(19) United States
(12) Patent Application Publication
(10) Pub. No.: US 2026/0034811 A1
(43) Pub. Date: Feb. 5, 2026

(54) PRINTING APPARATUS

(71) Applicant: CANON KABUSHIKI KAISHA, Tokyo (JP)

(72) Inventors: TOMOYA HARA, Kanagawa (JP); MASAKAZU TSUKUDA, Kanagawa (JP); HIROTAKA ENDO, Kanagawa (JP); MASAAKI MATSUURA, Kanagawa (JP); KEN TAKENAGA, Kanagawa (JP); TOSHIKI HAMANISHI, Kanagawa (JP); KATSUAKI SUKEGAWA, Kanagawa (JP)

(21) Appl. No.: 19/285,503

(22) Filed: Jul. 30, 2025

(30) Foreign Application Priority Data
Jul. 31, 2024 (JP) 2024-124817
Feb. 20, 2025 (JP) 2025-026009

(51) Int. Cl. B41J 13/10; B41J 3/46; B41J 3/60

(52) U.S. Cl. CPC B41J 13/106; B41J 3/46; B41J 3/60

(57) ABSTRACT

A technology that enables downsizing of an apparatus is to be provided. A printing apparatus includes: an accommodating unit configured to accommodate a print medium; a conveyance unit configured to convey the print medium fed from the accommodating unit in a first direction; a printing unit configured to perform printing on the print medium conveyed by the conveyance unit; and a first stacking part configured to stack the print medium, on which printing has been performed by the printing unit, at a first position and a second position which is different from the first position in a second direction intersecting with the first direction, wherein the first stacking part is arranged above the accommodating unit, below the printing unit.

### BACKGROUND

### Field of the Technology

The present disclosure relates to a printing apparatus that performs printing on a print medium.

### Description of the Related Art

There is a known technology in which, in a printing apparatus that discharges print media after printing and stacks them on a stacking part, the stacking part is moved to sort the print media into a certain number of sheets. The Japanese Patent Laid-Open No. 2015-160715 discloses a technology in which, while sorting print media, the stacking part is moved diagonally with respect to the conveyance direction, thereby ensuring an area where a bundle of print media to be sorted will not overlap with the already sorted bundle of print media.

However, in the technology disclosed in Japanese Patent Laid-Open No. 2015-160715, the stacking part is formed in a size capable of stacking print media of various sizes, and is installed such that a large part of the stacking part protrudes from the printing apparatus. Therefore, the printing apparatus has become large in size, and a large space has been required for installation of the printing apparatus.

### SUMMARY

The present disclosure has been made in view of the above-mentioned issue, and provides a technology that enables downsizing of an apparatus.

A printing apparatus embodiments includes an accommodating unit configured to accommodate a print medium; a conveyance unit configured to convey the print medium fed from the accommodating unit in a first direction; a printing unit configured to perform printing on the print medium conveyed by the conveyance unit; and a first stacking part configured to stack the print medium, on which printing has been performed by the printing unit, at a first position and a second position which is different from the first position in a second direction intersecting with the first direction, wherein the first stacking part is arranged above the accommodating unit, below the printing unit.

Features of the present disclosure will become apparent from the following description of embodiments with reference to the attached drawings. The following description of embodiment is described by way of example.

### BRIEF DESCRIPTION OF THE DRAWINGS

FIG. 1 is a perspective view illustrating the internal configuration of a printing apparatus;

FIG. 2A and FIG. 2B are a front view and plan view of a printing part;

FIG. 3A and FIG. 3B are diagrams describing the conveyance system of the printing part;

FIG. 4 is a block configuration diagram focusing on the control system of a stacking part in the printing part;

FIG. 5 is a perspective configuration diagram of the stacking part;

FIG. 6A and FIG. 6B are diagrams describing the range of movement of a front tray;

FIG. 7A and FIG. 7B are diagrams describing the sorting positions of the stacking part;

FIG. 8 is a perspective configuration diagram of a drive transmission part;

FIG. 9 is a perspective configuration diagram of a cam;

FIG. 10A to FIG. 10C are diagrams describing the movement of a reciprocating member using the cam;

FIG. 11 is a diagram describing how the stacking part is driven, depending on the rotation direction of a drive source;

FIG. 12 is a diagram showing a relation between FIGS. 12A and 12B;

FIGS. 12A and 12B are flowcharts illustrating details of processing of print processing;

FIG. 13A to FIG. 13F are diagrams illustrating the states of the stacking part that has been driven during the printing processing;

FIG. 14A and FIG. 14B are schematic configuration diagrams of a paper feeding unit;

FIG. 15A and FIG. 15B are schematic configuration diagrams of a printing unit;

FIG. 16A to FIG. 16C are diagrams illustrating the positional relationship of the constituent members in the printing part;

FIG. 17 is a diagram describing reversal conveying paths;

FIG. 18A and FIG. 18B are diagrams illustrating the width-direction lengths of the constituent members in the printing part;

FIG. 19 is a diagram describing another configuration for expanding and contracting the stacking part;

FIG. 20 is a diagram describing another configuration for moving the stacking part in the X direction;

FIG. 21A to FIG. 21C are diagrams describing a configuration for sorting print media stacked in the stacking part; and

FIG. 22A and FIG. 22B are diagrams describing another configuration for sorting print media stacked in the stacking part.

### DESCRIPTION OF THE EMBODIMENTS

Hereinafter, with reference to the accompanying drawings, detailed descriptions are given of examples of an embodiment of the printing apparatus. Note that the following embodiments are not intended to limit the present disclosure, and every combination of the characteristics described in the present embodiments is not necessarily essential to the solution provided in the present disclosure. Further, the positions, shapes, etc., of the constituent elements described in the embodiments are merely examples and are not intended to limit the scope of this disclosure thereto.

In the present embodiments, as an example of the printing apparatus, a description is given of a multifunction peripheral that has a printing function for ejecting ink as a printing agent using an inkjet system to perform printing on a print medium and a reading function for reading a document placed on a platen glass. Note that the printing system is not limited to the inkjet system, and may be, for example, electrophotographic system or various other known systems. Printing agents that can be ejected by the printing apparatus according to the present embodiments are not limited to ink, and include various known printing agents used for printing, such as a processing liquid for applying a predetermined treatment to the ejected ink.

In the present specification, viewing from a position facing the side to which print media are discharged after printing, the direction from the left side toward the right side of the printing apparatus is described as the X direction, the direction from the rear side (the back side) toward the near side (the front side) of the printing apparatus is described as the Y direction, and the direction from the lower side toward the upper side of the printing apparatus is described as the Z direction. In this way, the X direction, Y direction, and Z direction are directions from one side toward the other side, and are orthogonal to one another. In the present specification, each direction is represented with a “+ (plus)” in a case where movement is from the one side toward the other side, and with a “− (minus)” in a case where movement is from the other side toward the one side, as appropriate.

### First Embodiment

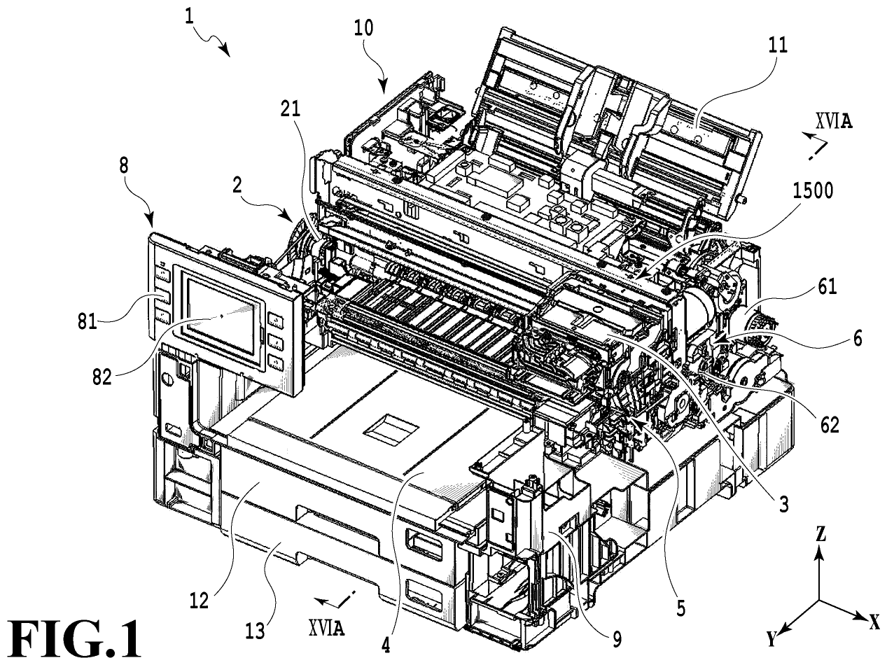

First, with reference to FIG. 1 to FIG. 18B, a description is given about the printing apparatus according to the first embodiment.

### (Configuration of the Printing Apparatus)

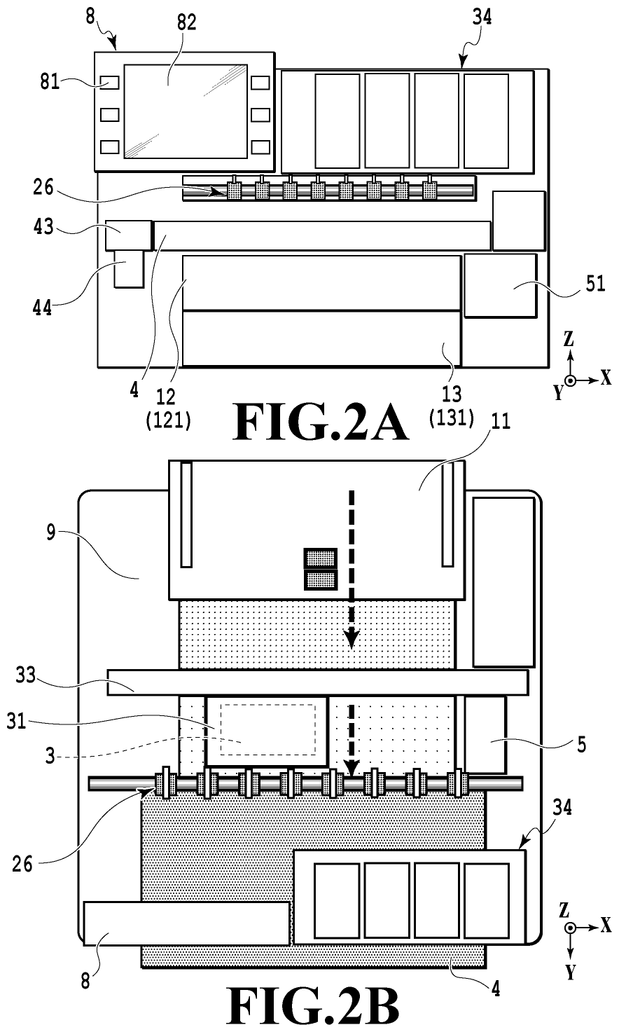

A description is given about the overall configuration of the printing apparatus according to the present embodiment. FIG. 1 is a perspective view of the internal configuration of the printing apparatus. FIG. 2A is a front view of a printing part, and FIG. 2B is a plan view of the printing part. Note that in FIG. 1, illustrations of some configurations are omitted for ease of understanding.

The printing apparatus 1 is a multifunction peripheral including the printing part 10 that performs printing on print media, and a scanner part (not illustrated in the drawings) arranged above the printing part 10 to read documents. In the printing apparatus 1, various processes related to a printing operation and reading operation are executed either individually or cooperatively by the printing part 10 and the scanner part.

The scanner part includes an ADF (automatic document feeder) and an FBS (flatbed scanner) and is capable of reading a document automatically fed by the ADF as well as reading a document placed on the platen glass of the FBS by the user. Note that although the printing apparatus 1 is a multifunction peripheral including the printing part 10 and the scanner part in the present embodiment, a form without the scanner part is also possible.

The printing part 10 includes the first paper feeding part 11, the second paper feeding part 12, and the third paper feeding part 13 for feeding print media (see FIG. 1). Further, the printing part 10 includes the conveyance part 2 that conveys print media fed from each paper feeding part, the print head 3 that performs printing by ejecting ink onto the print media conveyed by the conveyance part 2, and the stacking part 4 for stacking the print media after printing. Furthermore, the printing part 10 includes the maintenance part 5 that performs maintenance of the print head 3, and the drive part 6 that drives the first paper feeding part 11, the second paper feeding part 12, the third paper feeding part 13, and the maintenance part 5.

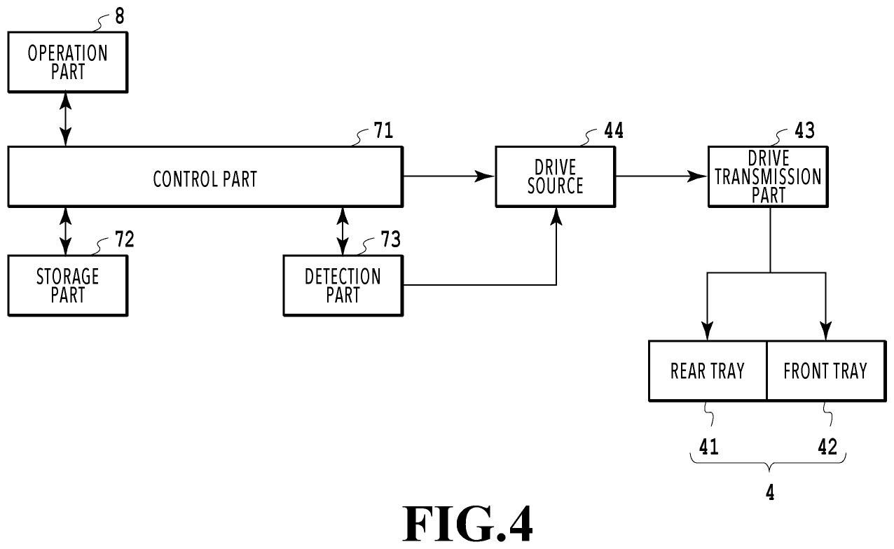

The printing part 10 includes the liquid storage part 34 for storing the ink to be supplied to the print head 3, and the ink discharge part 51 for storing the ink discharged from the maintenance part 5 (see FIG. 2A and FIG. 2B). Further, the printing part 10 includes the control part 71 (see FIG. 4) that controls the overall operation of the printing apparatus 1, such as the control of driving the conveyance part 2, the print head 3, the stacking part 4, and the drive part 6. Furthermore, the printing part 10 includes the operation part 8 capable of receiving input operations by the user and displaying various information. The operation part 8 is equipped with the operation button 81 for inputting operation information to the printing apparatus 1, and the display panel 82 for displaying operation information. In the printing apparatus 1, each of the above-described configurations is fastened to the housing 9 to constitute the printing part 10.

In the printing part 10, the operation part 8 and the liquid storage part 34 are arranged above the stacking part 4. More specifically, the operation part 8 and the liquid storage part 34 are each arranged at positions partially overlapping the stacking part 4 in the XY plane (see FIG. 2B). Note that the operation part 8 and the liquid storage part 34 are arranged with a space from the stacking part 4 in the Z direction (see FIG. 2A). In the present embodiment, the operation part 8 is arranged on one side (the left side) in the X direction, and the liquid storage part 34 is arranged on the other side (the right side) in the X direction. Note that it is also possible that the layout of the operation part 8 and the liquid storage part 34 in the X direction is reversed.

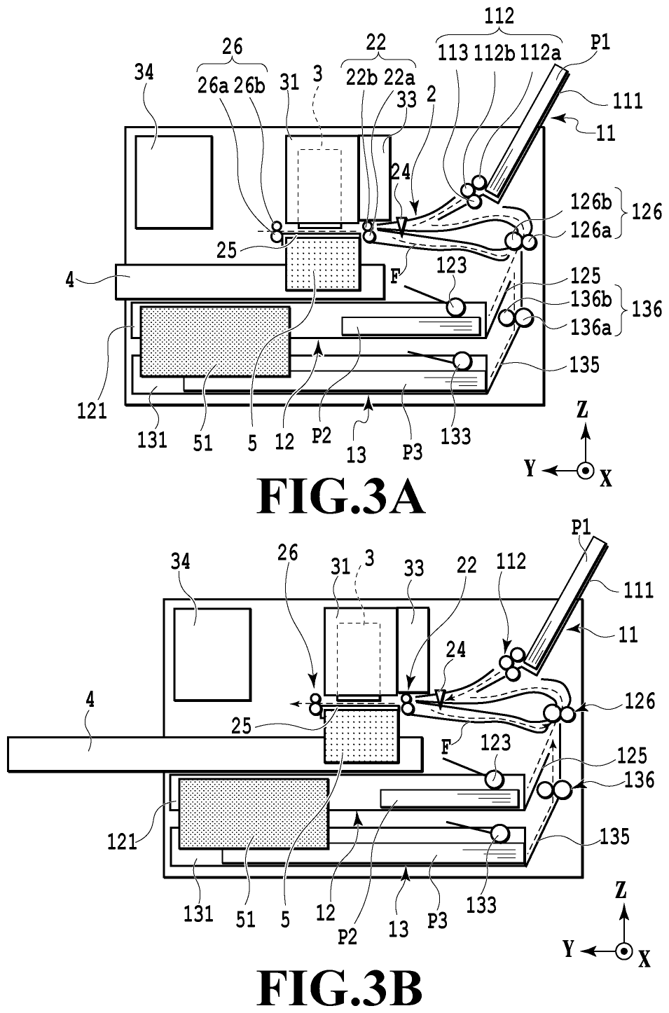

Further, in the printing part 10, the operation part 8 and the liquid storage part 34 are arranged on the other side in the Y direction (the front side) relative to the paper discharge roller pair 26, i.e., on the downstream side in the conveyance direction of print media to be discharged by the paper discharge roller pair 26. Additionally, in the printing part 10, the maintenance part 5 is arranged within the movement area of the print head 3, on the other side of the stacking part 4 in the X direction. More specifically, the maintenance part 5 is arranged at a position partially overlapping with the stacking part 4 in the YZ plane (see FIG. 3A). Furthermore, in the printing part 10, the ink discharge part 51 is arranged below the stacking part 4. More specifically, the ink discharge part 51 is arranged at a position partially overlapping with the stacking part 4 in the XY plane (see FIG. 2A and FIG. 3A).

### (Conveyance Part and Paper Feeding Part)

Next, a description is given about the configuration of the conveyance system of the printing part 10. FIG. 3A and FIG. 3B are diagrams illustrating the configuration of the conveyance system of the printing part 10, with FIG. 3A illustrating the state before the stacking part 4 expands, and FIG. 3B illustrating the state after the stacking part expands.

### <Conveyance Part>

The conveyance part 2 includes the conveyance roller pair 22 that conveys the print medium fed from each paper feeding part to the printing position where printing can be performed by the print head 3, and the paper discharge roller pair 26 that discharges the print medium after printing is performed by the print head 3. The conveyance roller pair 22 includes the conveyance roller 22a that is driven by the conveyance motor 21 (see FIG. 1), and the pinch roller 22b that is in pressure contact and associates with the conveyance roller 22a. At the conveyance roller pair 22, the print medium is nipped and conveyed by the conveyance roller 22a and the pinch roller 22b. The paper discharge roller pair 26 includes the paper discharge roller 26a that is driven by the conveyance motor 21, and the spur 26b that is in pressure contact with the paper discharge roller 26a. At the paper discharge roller pair 26, the print medium is nipped and conveyed by the paper discharge roller 26a and the spur 26b.

Further, the conveyance part 2 includes the first intermediate roller pair 126 that conveys the print media fed from the second paper feeding part 12 and the third paper feeding part 13 to the conveyance roller pair 22, and the second intermediate roller pair 136 that conveys the print medium fed from the third paper feeding part 13 to the first intermediate roller pair 126. The first intermediate roller pair 126 includes the first intermediate roller 126a that is driven by the drive part 6, and the first driven roller 126b that is in pressure contact and associates with the first intermediate roller 126a. At the first intermediate roller pair 126, the print medium is nipped and conveyed by the first intermediate roller 126a and the first driven roller 126b. Further, the second intermediate roller pair 136 includes the second intermediate roller 136a that is driven by the drive part 6, and the second driven roller 136b that is in pressure contact and associates with the second intermediate roller 136a. At the second intermediate roller pair 136, the print medium is nipped and conveyed by the second intermediate roller 136a and the second driven roller 136b.

Note that after the print medium fed from each paper feeding part passes through the detection lever 24 located on the upstream side of the conveyance direction relative to the conveyance roller pair 22, the positions of the left and right front edges of the print medium in the width direction are aligned with the conveyance direction by the conveyance roller pair 22. That is, the skew of the print medium in the conveyance direction is corrected by the conveyance roller pair 22.

### <Paper Feeding Part>

### =First Paper Feeding Part=

The first paper feeding part 11 includes the pressure plate 111 on which a print medium is placed, and the first paper feeding roller part 112 that feeds the print medium placed on the pressure plate 111 to the conveyance roller pair 22. The first paper feeding roller part 112 includes the first paper feeding rollers 112a and 112b that feed the print medium to the conveyance roller pair 22. Further, the first paper feeding roller part 112 includes the separation roller 113 that is arranged at a position opposed to the first paper feeding roller 112b and applies resistance to the print medium fed by the first paper feeding roller 112b. The first paper feeding rollers 112a and 112b are driven by the driving force of the driving motor 61 (see FIG. 1) of the drive part 6.

In the first paper feeding part 11, the print medium P1 stacked on the pressure plate 111 abuts on the first paper feeding roller 112a, which rotates under the driving of the driving motor 61, thereby starting the feeding of the print medium P1. The print medium P1 fed by the first paper feeding roller 112a is fed by the first paper feeding roller 112b, which is arranged on the downstream side in the feeding direction relative to the first paper feeding roller 112a. At this time, only the topmost sheet of the print media P1 fed by the first paper feeding roller 112b is fed to the conveyance roller pair 22 by the separation roller 113, which is arranged at the position opposed to the first paper feeding roller 112b.

### =Second Paper Feeding Part=

The second paper feeding part 12 includes the cassette case 121 that accommodates a print medium, the second paper feeding roller 123 that feeds the print medium accommodated in the cassette case 121, and the separation part 125 that applies resistance to the print medium fed by the second paper feeding roller 123. The second paper feeding roller 123 is driven by the driving force of the driving motor 62 of the drive part 6 (see FIG. 1) transmitted through a gear train (not illustrated in the drawings).

In the second paper feeding part 12, upon driving of the driving motor 62, the second paper feeding roller 123 rotates while abutting on the print medium P2 accommodated in the cassette case 121, thereby starting the feeding of the print medium P2 to the first intermediate roller pair 126. To the print medium P2 fed by the second paper feeding roller 123, resistance against the feeding direction is applied by the separation part 125. Accordingly, even if multiple print media P2 are fed by the second paper feeding roller 123, only the topmost sheet of the print media P2 is fed to the first intermediate roller pair 126 by the separation part 125. The print medium P2 fed to the first intermediate roller pair 126 is conveyed to the conveyance roller pair 22 by the first intermediate roller pair 126.

### =Third Paper Feeding Part=

The third paper feeding part 13 includes the cassette case 131 that accommodates a print medium, the third paper feeding roller 133 that feeds the print medium accommodated in the cassette case 131, and the separation part 135 that applies resistance to the print medium fed by the third paper feeding roller 133. The third paper feeding roller 133 is driven by the driving force of the driving motor 62 of the drive part 6 (see FIG. 1) transmitted through a gear train (not illustrated in the drawings).

In the third paper feeding part 13, upon driving of the driving motor 62, the third paper feeding roller 133 rotates while abutting on the print medium P3 accommodated in the cassette case 131, thereby starting the feeding of the print medium P3 to the second intermediate roller pair 136. To the print medium P3 fed by the third paper feeding roller 133, resistance against the feeding direction is applied by the separation part 135. Accordingly, even if multiple print media P3 are fed by the third paper feeding roller 133, only the topmost sheet of the print media P3 is fed to the second intermediate roller pair 136 by the separation part 135. The print medium P3 fed to the second intermediate roller pair 136 is conveyed to the conveyance roller pair 22 by the second intermediate roller pair 136 and the first intermediate roller pair 126.

### (Print Head)

Next, a description is given about the print head 3. In the printing part 10, the print head 3 is supported in a slidable manner on the chassis 33 extending in the X direction, and is mounted on the carriage 31 configured to be capable of reciprocal movement in the X direction (see FIG. 2B and FIG. 3A). Accordingly, the print head 3 is able to move reciprocally in the X direction via the carriage 31. The print medium conveyed by the conveyance roller pair 22 is supported by the platen 25 placed at the position opposed to the print head 3. Further, while moving in the X direction via the carriage 31, the print head 3 ejects ink onto the print medium supported by the platen 25 to perform printing.

In a case where printing is performed only on one side of the print medium, the print medium after printing is discharged to the stacking part 4 via the paper discharge roller pair 26. On the other hand, in a case where printing is performed on both sides of the print medium, the conveyance motor 21 is rotated in the reverse direction with the rear edge of the print medium, after printing on one side, being nipped by the paper discharge roller pair 26. Accordingly, the paper discharge roller pair 26 and the conveyance roller pair 22 rotate in the direction opposite to the rotation for conveying the print medium in the conveyance direction, so as to convey the print medium nipped at the rear edge by the paper discharge roller pair 26 to the reversal conveying path F. In the description provided herein, it is assumed that the rear edge of a print medium refers to the rear edge of a print medium in the conveyance direction (+Y direction), and the front edge of a print medium refers to the front edge of a print medium in the conveyance direction.

Then, once the front edge of the print medium conveyed to the reversal conveying path F passes through the conveyance roller pair 22, the conveyance motor 21 is switched to forward rotation. After that, upon passing through the detection lever 24 due to conveyance by the first intermediate roller pair 126, skew correction is performed again by the conveyance roller pair 22. Subsequently, the same operation as that for printing on one side of the print medium is performed, so that after printing on the other side of the print medium, the print medium printed on both sides is discharged to the stacking part 4 by the paper discharge roller pair 26.

Note that, although details are described later, in the present embodiment, the stacking part 4 where the print media discharged via the paper discharge roller pair 26 are stacked automatically expands in the +Y direction during printing (see FIG. 3B). Accordingly, the stacking part 4, most of which is inside the housing 9 before expansion, protrudes outside the housing 9, thereby ensuring the area to stably stack the discharged print media. Note that the stacking part 4 is detachable from the housing 9. By removing the stacking part 4 from the housing 9, the user can insert their hand into the housing 9 to remove a jammed print medium in the conveyance path.

### (Stacking Part)

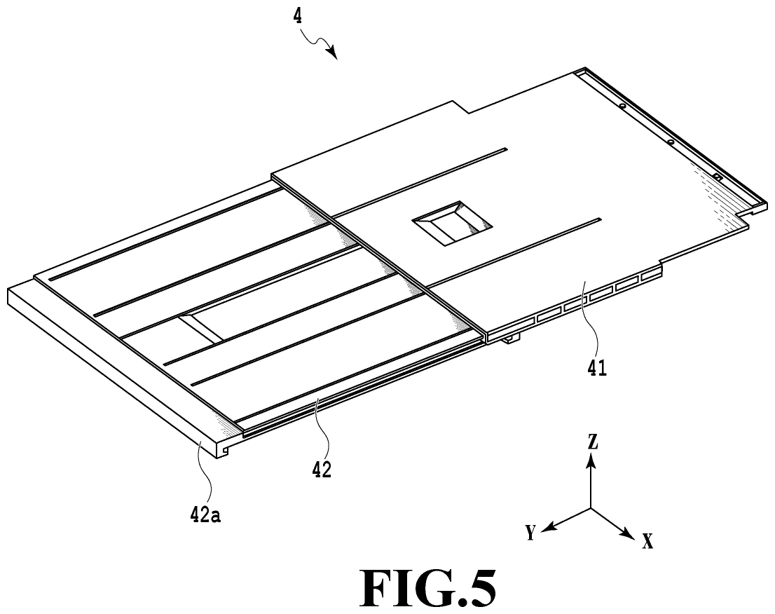

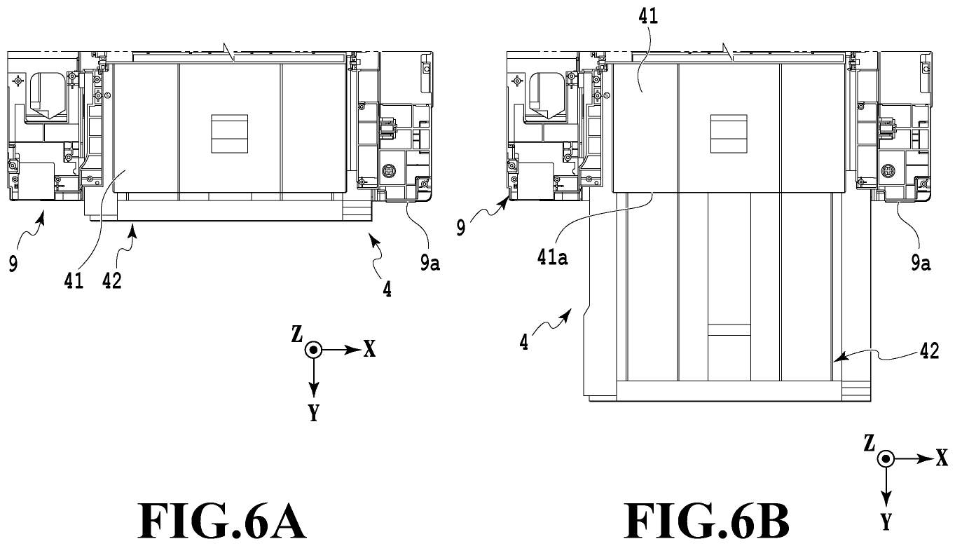

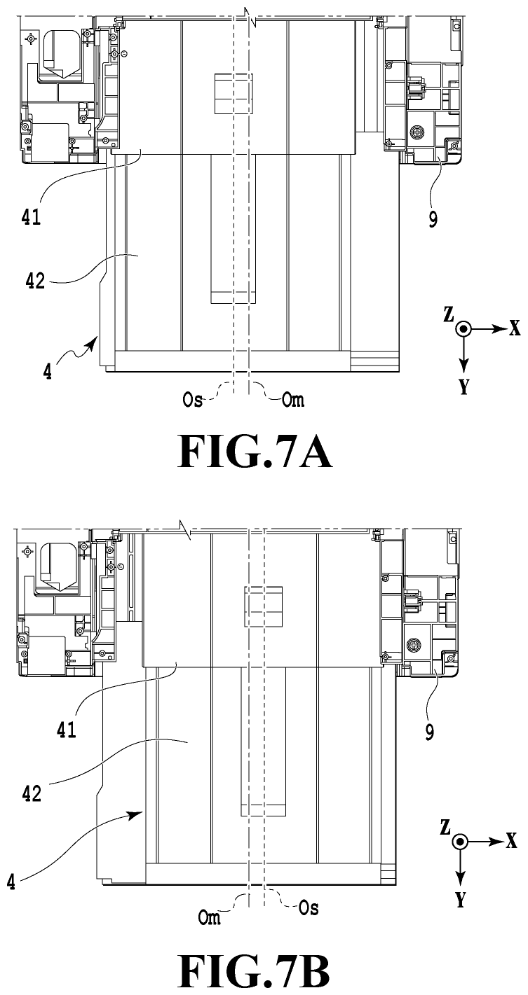

Next, a description is given about the stacking part 4. FIG. 4 is a block diagram illustrating the configuration of the control system of the printing apparatus 1. Note that, to focus on the stacking part 4 in the following description, the control configuration related to the stacking part 4 is mainly illustrated in FIG. 4, and other configurations are omitted. FIG. 5 is a perspective configuration diagram of the stacking part 4. FIG. 6A and FIG. 6B are diagrams illustrating the positions of the stacking part 4 after expansion and after contraction, with FIG. 6A illustrating the accommodated position of the front tray 42 after the stacking part 4 contracts, and FIG. 6B illustrating the stack position of the front tray 42 after the stacking part 4 expands. FIG. 7A and FIG. 7B are diagrams illustrating two sorting positions of the stacking part 4, with FIG. 7A illustrating the first sorting position, and FIG. 7B illustrating the second sorting position.

The stacking part 4 for stacking the print media discharged by the paper discharge roller pair 26 automatically expands upon the start of printing, thereby expanding the area that supports the discharged print media. Further, upon removal of the print media from the stacking part 4, the stacking part 4 automatically contracts, thereby reducing that area. Furthermore, the stacking part 4 has a function to move in a direction (the X direction) intersecting (orthogonally in the present embodiment) with the expansion and contraction direction (the Y direction) to sort the discharged print media. Note that the automatic contraction of the stacking part 4 in the printing part 10 is executed not only upon removal of the print media from the stacking part 4 but also upon receiving an instruction from the user via the operation part 8, upon absence of a printing operation for a predetermined time, upon switching to a low power mode, or the like.

The printing part 10 includes the control part 71, the storage part 72, the detection part 73, the operation part 8, the stacking part 4, the drive transmission part 43, and the drive source 44 (see FIG. 4).

During the time after receiving a printing command until the print medium is conveyed and discharged onto the stacking part 4, the control part 71 controls the stacking part 4 to complete the movement in the X direction and the expansion in the Y direction. Further, if the print media are removed from the stacking part 4, the control part 71 controls the stacking part 4 to start moving in the X direction and contracting in the Y direction. Although details are described later, the stacking part 4 is expanded after moving in the X direction to the first sorting position (which is described later). In the expansion of the stacking part 4, the front tray 42 that constitutes the stacking part 4 moves from the accommodated position (which is described later) to the stack position (which is described later). Further, the stacking part 4 is contracted after moving in the X direction to the second sorting position (which is described later) that is different from the first sorting position. In the contraction of the stacking part 4, the front tray 42 that constitutes the stacking part 4 moves from the stack position to the accommodated position. With this control, during discharge of a print medium, it is possible to reduce the influence of external force imposed on print media due to the movement of the stacking part 4. That is, it is possible to suppress deterioration in the alignment of the print media discharged and stacked, and thus while sorting print media, the visibility of the sorted print media is improved. Further, since the stacking part 4 automatically expands and contracts, there is no burden on the user, enhancing usability. Note that details of the driving control for the movement and expansion of the stacking part 4 by the control part 71 are described later.

The operation part 8 includes the operation button 81 and the display panel 82 (see FIG. 1). By operating the operation part 8, the user can select whether or not sorting of print media is required and issue an instruction for moving the stacking part 4. Note that in the printing part 10, sorting of print media and movement of the stacking part 4 can also be executed based on information set in a job, for example. The storage part 72 stores various programs for operating the stacking part 4. Upon input from the user through the operation part 8, the control part 71 reads the program corresponding to the input result to perform control of driving the stacking part 4. Further, the storage part 72 holds detection results from the detection part 73.

The detection part 73 includes multiple sensors. Specifically, a sensor that detects the rotation of the drive source 44 (see FIG. 2A) for driving the stacking part 4 is included. The sensor is configured with a rotary encoder and is installed on the rotary axis of the drive source 44 that generates a rotational driving force. The sensor converts the rotational angle of the drive source 44 into a number of steps and transmits it to the control part 71. The control part 71 reads, from the storage part 72, the number of steps required for a predetermined operation of the stacking part 4, and in a case where the number of steps transmitted from the sensor reaches the specified number of steps, the control part 71 determines that the predetermined operation of the stacking part 4 is completed and stops the drive source 44. In the present embodiment, the sensor is configured with an encoder installed on the rotary axis of the drive source 44; however, there is no such limitation. For example, installation on the rotary axis of a predetermined transmission member that constitutes the drive transmission part 43 (see FIG. 2A), which transmits the driving force of the drive source 44 to the stacking part 4, is also possible.

Further, the detection part 73 includes a sensor that detects the position of the stacking part 4 after the predetermined operation. As this sensor, for example, a mechanical switch, a photo sensor, or the rotary encoder of the drive source 44 may be used. Furthermore, the detection part 73 includes a sensor that detects whether or not any print medium is stacked on the stacking part 4. With this sensor, it is possible to detect the timing to contract the stacking part 4.

The stacking part 4 includes the rear tray 41 and the front tray 42 (see FIG. 5). The rear tray 41 is configured to be capable of reciprocal movement in the X direction, which intersects with the direction (the Y direction) in which print media are discharged. The rear tray 41 is arranged within the housing 9, and the other end portion 41a in the Y direction is arranged further back in the Y direction relative to the front surface 9a of the housing 9 (see FIG. 6A).

The front tray 42 is supported by the rear tray 41 and is configured to be capable of reciprocal movement in the Y direction in the rear tray 41. Accordingly, the front tray 42 is able to reciprocally move in the X direction via the rear tray 41.

The front tray 42 is configured to be movable between the accommodated position and the stack position (see FIG. 6A and FIG. 6B). The accommodated position is such that most of the front tray 42 overlaps with the rear tray 41 in the XY plane and is accommodated below the rear tray 41 (see FIG. 6A). The stack position is a position drawn out from the accommodated position so that the front tray 42 cooperates with the rear tray 41 to be able to stack print media (see FIG. 6B). That is, at the time the stacking part 4 expands, the front tray 42 moves in the +Y direction from the accommodated position to the stack position. Further, at the time the stacking part 4 contracts, the front tray 42 moves in the −Y direction from the stack position to the accommodated position. Note that in the present embodiment, in the accommodated position, a partial area on the end portion 42a side of the front tray 42 protrudes in the Y direction relative to the front surface 9a of the housing 9. With this configuration, at the time the front tray 42 is in the accommodated position, most of the stacking part 4 is positioned inside the housing 9, thereby reducing the installation space of the printing apparatus 1.

Regarding the stack position, multiple different positions can be taken in the Y direction according to the size of the print media. In the present embodiment, as the stack position, four stack positions corresponding to A4, A5, B5, and LETTER sizes, respectively, can be taken. Note that the positions that can be taken as the stack position are not limited to these.

Further, by the movement of the rear tray 41 in the X direction, the stacking part 4 is configured to be movable between two sorting positions for sorting the print media to be discharged. That is, in the X direction, the stacking part 4 can move between the first sorting position where the center position Os of the stacking part 4 is positioned on one side of the center position Om of the print media to be discharged (see FIG. 7A) and the second sorting position where the center position Os is positioned on the other side of the center position Om (see FIG. 7B). The stacking part 4 is configured to be capable of sorting the print media to be discharged at the positions offset from each other in the X direction by stacking the print media at the first sorting position and stacking the print media at the second sorting position. In other words, the first sorting position and the second sorting position are positioned a predetermined distance apart from each other in the X direction.

In the present embodiment, the distance from the center position Os to the center position Om at the first sorting position may be designed to match the distance from the center position Os to the center position Om at the second sorting position. Alternatively, it is also possible that the distance from the center position Os to the center position Om at the first sorting position is designed to differ from the distance from the center position Os to the center position Om at the second sorting position. The distance required for sorting, i.e., the distance between the first sorting position and the second sorting position, is set to be, for example, 30 mm or more and 50 mm or less. The positions where the stacking part 4 can stay are not limited to the first sorting position and the second sorting position. For example, it is also possible to adopt a configuration in which the stacking part 4 is positioned at the center position Om in a case where sorting is not performed during print processing, in a case where printing is not performed, or the like.

### (Drive Transmission Part)

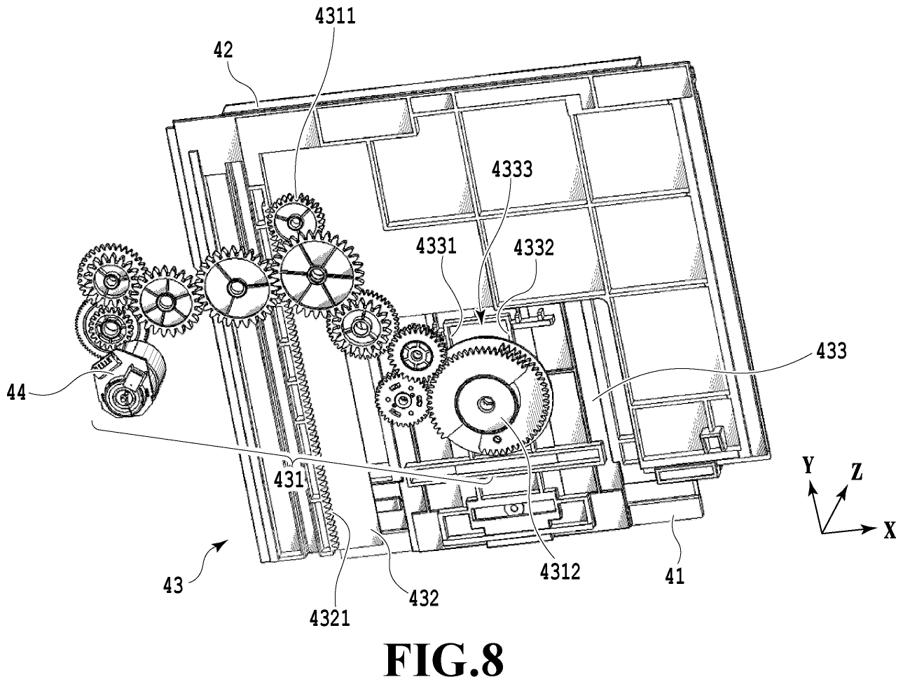

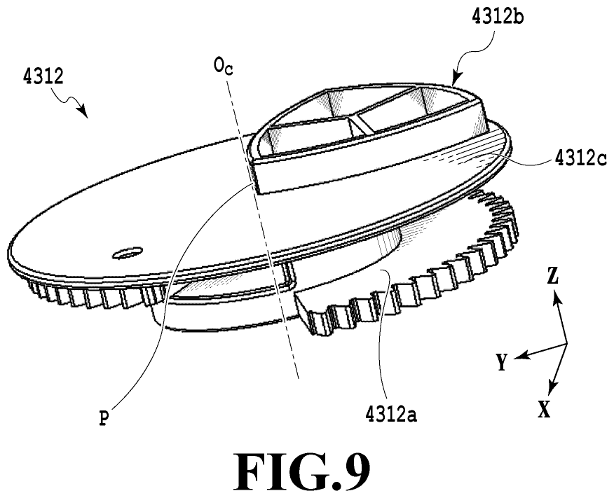

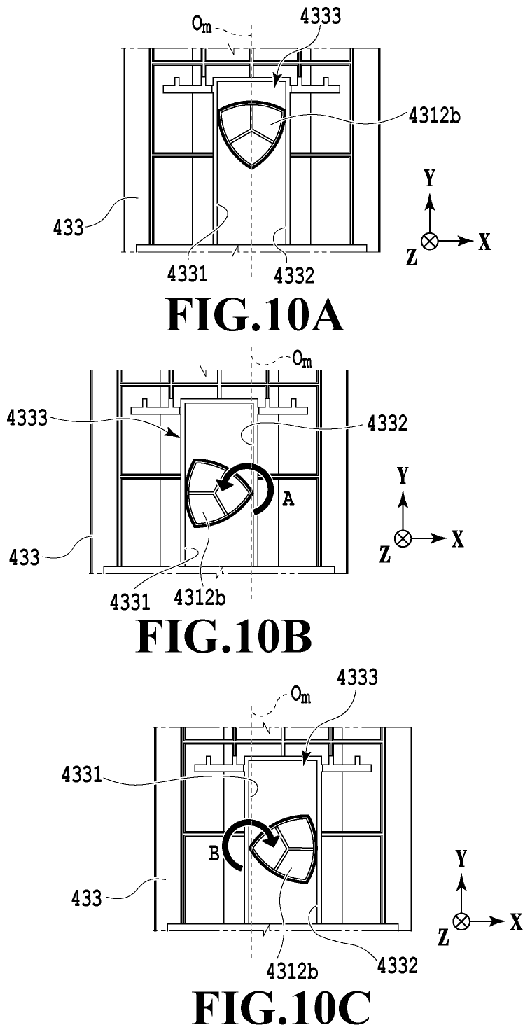

Next, a description is given of the drive transmission part 43. FIG. 8 is a perspective view of the drive transmission part 43. FIG. 9 is a perspective view of the cam, which is a constituent member of the drive transmission part 43. FIG. 10A to FIG. 10C are diagrams describing the movement of the stacking part 4 in the X direction using the cam.

The drive transmission part 43 includes the drive train 431 configured with multiple drive transmission members that transmit the rotational driving force from the drive source 44, and the support member 432 that can move in the Y direction by the driving force transmitted via the drive train 431 (see FIG. 8). Further, the drive transmission part 43 includes the reciprocating member 433 that is capable of moving in the X direction by the driving force transmitted via the drive train 431, and a casing (not illustrated in the drawings) that holds the drive source 44 and the drive train 431.

The support member 432 includes the rack part 4321 that extends in the Y direction. This rack part 4321 meshes with the pinion 4311, which is one of the drive transmission members that constitute the drive train 431, thereby allowing the support member 432 to move in the Y direction by the driving force transmitted from the drive train 431. Specifically, the drive train 431 is configured with multiple gears, including the pinion 4311. The driving force transmitted from the drive source 44 is transmitted to the pinion 4311 via a predetermined gear in the drive train 431, causing the support member 432 to move in the Y direction due to the driving force transmitted to the pinion 4311.

One end of the drive train 431 is connected to the drive source 44. Further, at the other end of the drive train 431, the cam 4312 that engages with the reciprocating member 433 is positioned. The cam 4312 includes the circular plate part 4312c, the gear part 4312a formed on one surface of the plate part 4312c, and the cam part 4312b formed on the other surface of the plate part 4312c (see FIG. 9). The driving force from the drive source 44 is transmitted to the gear part 4312a, thereby causing the cam 4312 to rotate about the rotational center, i.e., the axis Oc that passes through the center of the plate part 4312c and is parallel to the Z direction. In the present embodiment, the cam part 4312b has a substantially triangular cylindrical shape, and each side connecting adjacent vertices of the triangle is gently curved to protrude outward (see FIG. 10A). Further, the cam part 4312b is formed on the other surface of the plate part 4312c eccentrically with respect to the rotational center such that the predetermined vertex P is positioned on the axis Oc.

The reciprocating member 433 has the engagement part 4333 formed to engage with the cam part 4312b. The engagement part 4333 has the first sliding surface 4331 and the second sliding surface 4332 which are formed to face each other with a predetermined space in the X direction such that the engaging cam part 4312b can slide therein. Note that the predetermined space corresponds to the length of the cam part 4312b in the X direction. Further, the first sliding surface 4331 and the second sliding surface 4332 are formed parallel to the Y direction. As mentioned above, the cam part 4312b is eccentric with respect to the rotational center of the cam 4312. Accordingly, if the cam 4312 rotates, the cam part 4312b slides on the first sliding surface 4331 or the second sliding surface 4332, thereby moving the reciprocating member 433 in the +X direction or −X direction (see FIG. 10A to FIG. 10C).

For example, assume that, by a rotation of the cam 4312, the cam part 4312b has rotated from a predetermined position (the position illustrated in FIG. 10A) in the direction of arrow A (see FIG. 10B). In this case, the cam part 4312b slides on the first sliding surface 4331, thereby moving the reciprocating member 433 to one side (the −X direction) from the other side in the X direction (see FIG. 10B). Further, assume that, by a rotation of the cam 4312, the cam part 4312b has rotated from a predetermined position in the direction of arrow B (see FIG. 10C). In this case, the cam part 4312b slides on the second sliding surface 4332, thereby moving the reciprocating member 433 from one side to the other side (+X direction) in the X direction (see FIG. 10C).

The support member 432 is connected to the front tray 42. Therefore, in conjunction with the movement of the support member 432 in the Y direction, the front tray 42 moves in the Y direction. Further, the reciprocating member 433 is connected to the rear tray 41. Therefore, in conjunction with the movement of the reciprocating member 433 in the X direction, the rear tray 41 moves in the X direction, and the front tray 42 also moves in the X direction via the rear tray 41. In the present embodiment, the support member 432 is connected to the front tray 42 and the reciprocating member 433 is connected to the rear tray 41; however there is no such limitation. For example, the rack part 4321 may be formed on the front tray 42, allowing the front tray 42 to have the function of the support member 432, or the engagement part 4333 may be formed on the rear tray 41, allowing the rear tray 41 to have the function of the engagement part 4333. Thus, in the present embodiment, the drive transmission part 43 and the drive source 44 function as a movement mechanism that moves the stacking part 4 in the X direction and the Y direction.

### (Overview of the Movements of the Rear Tray and the Front Tray)

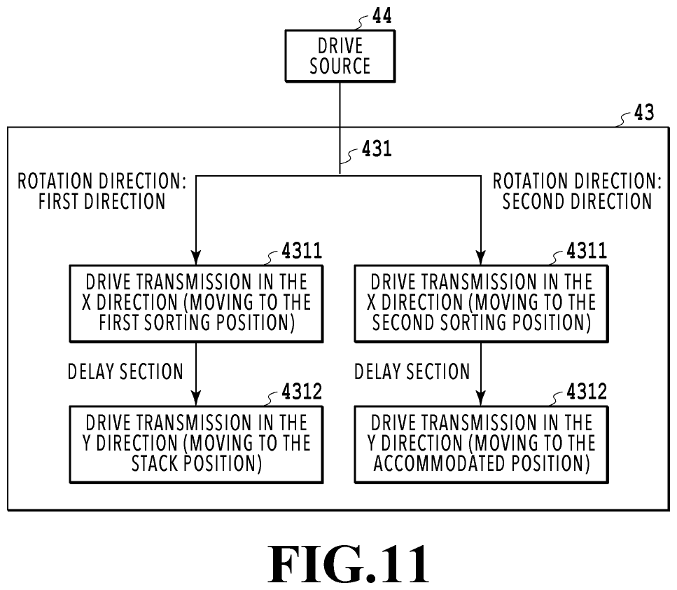

Next, a description is given of an overview of the movements of the rear tray 41 and the front tray 42. FIG. 11 is a diagram illustrating an overview of the movements of the rear tray 41 and the front tray 42.

In the drive train 431, a delay section is formed in the drive transmission path for the Y direction. Specifically, the drive train 431 is configured to start the movement of the front tray 42 in the Y direction after the movement of the rear tray 41 in the X direction is completed. More specifically, in a case where the rotation direction of the drive source 44 is in the first direction, the rear tray 41 is moved to the first sorting position, and the front tray 42 is also moved to the first sorting position via the rear tray 41. Subsequently, the drive source 44 is further rotated in the first direction, thereby expanding the front tray 42 relative to the rear tray 41, that is, the front tray 42 in the accommodated position is moved in the +Y direction to the stack position. In a case where the rotation direction of the drive source 44 is the second direction, which is opposite to the first direction, the rear tray 41 is moved to the second sorting position, and the front tray 42 is also moved to the second sorting position via the rear tray 41. Subsequently, the drive source 44 is further rotated in the second direction, thereby contracting the front tray 42 relative to the rear tray 41, that is, the front tray 42 in the stack position is moved in the −Y direction to the accommodated position.

In the present embodiment, the drive transmission part 43 moves the front tray 42 in the Y direction after moving the rear tray 41 in the X direction; however, there is no such limitation. For example, it is also possible to move the rear tray 41 in the X direction after moving the front tray 42 in the Y direction. Further, various known transmission mechanisms, such as a link mechanism, may be used as a configuration for transmitting the driving force of the drive source 44. Furthermore, the printing part 10 may include multiple drive sources, so that the movement of the rear tray 41 in the X direction and the movement of the front tray 42 in the Y direction are executed by the driving force from different drive sources. Note that the movement of the rear tray 41 in the X direction and the movement of the front tray 42 in the Y direction may be executed not only by the drive source 44 but also manually by the user.

### (Print Processing)

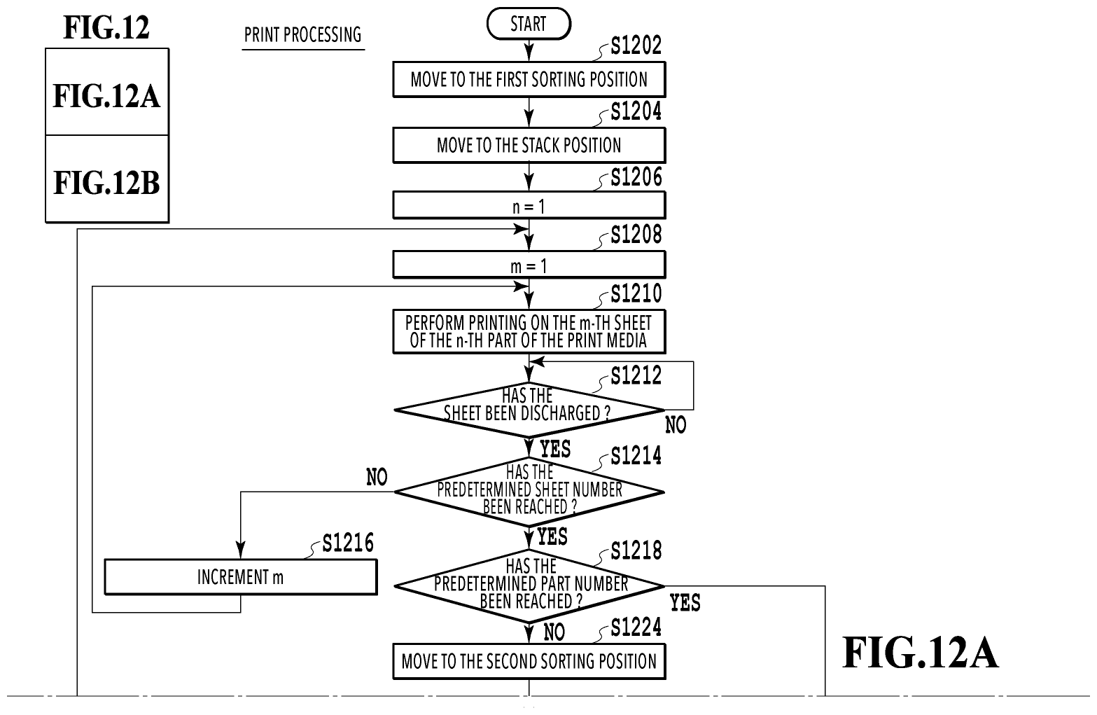

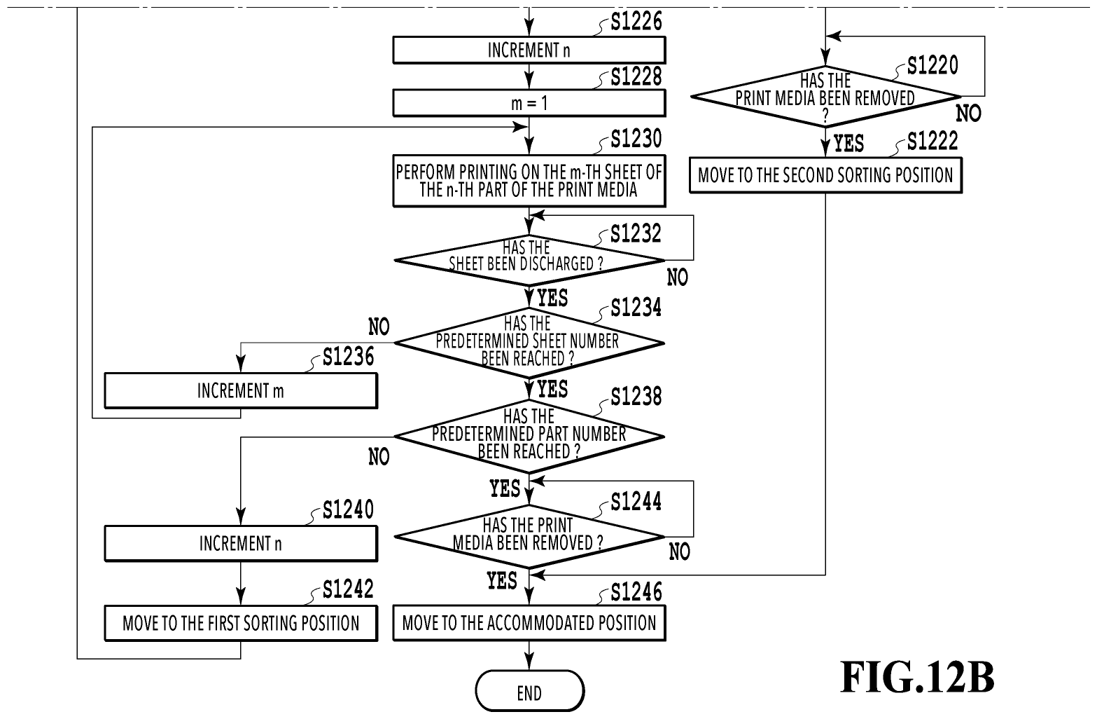

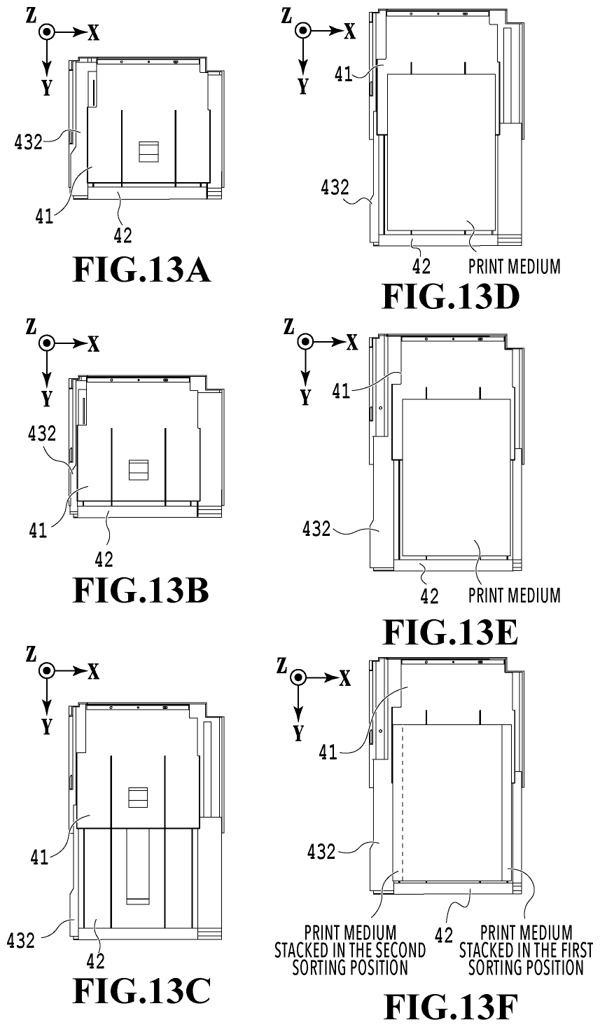

Next, a description is given about the print processing in which, while printing is performed on print media, the print media after printing are sorted in the stacking part 4. FIG. 12 is a flowchart illustrating the details of processing of the print processing in which, while printing is performed on print media, the print media after printing are sorted in the stacking part 4. FIG. 13A to FIG. 13F are diagrams illustrating the states after the stacking part 4 is moved. The series of processes illustrated in the flowchart of FIG. 12 is performed by the control part 71 loading a program code stored in a program memory (not illustrated in the drawings) of the storage part 72 into a data memory (not illustrated in the drawings) in the storage part 72 and executing it. Alternatively, part or all of the functions in the steps of FIG. 12 may be executed by hardware such as an ASIC (application-specific integrated circuit), an electronic circuit, or the like. In the present specification, the sign “S” in the description of each process in the flowchart indicates a step in the flowchart. Note that in the explanation of the print processing using FIG. 12, a case is described in which a bundle of M sheets of print media is treated as one part, and print processing is executed by the printing apparatus 1 based on a job for executing printing to generate N parts of such bundles of print media.

At the start of the print processing, first, in S1202, the control part 71 moves the rear tray 41 and the front tray 42 to the first sorting position. In S1202, the drive source 44 is rotated in the first direction to move the rear tray 41 and the front tray 42, which are at the initial position (see FIG. 13A), in the −X direction to the first sorting position (see FIG. 13B). Next, in S1204, the control part 71 moves the front tray 42 from the accommodated position to the stack position. In S1204, in the state where the rear tray 41 and the front tray 42 are at the first sorting position, the drive source 44 is further rotated in the first direction, thereby moving the front tray 42 in the +Y direction from the accommodated position to the stack position (see FIG. 13C). In the present embodiment, the stack position changes according to the size of the print media. That is, in the present embodiment, the expansion amount of the stacking part 4 varies depending on the size of the print media. Therefore, in S1204, the stack position is determined based on a detection result of a sensor installed in the detection part 73 to detect the position of the stacking part 4 after a predetermined operation. Specifically, for example, based on a detection result of a rotary encoder of the drive source 44, the front tray 42 is moved to the stack position corresponding to the size of the print media. Alternatively, it is also possible to adopt a configuration in which the front tray 42 is moved to the stack position corresponding to the size of the print media based on a detection result of a mechanical switch, a photo sensor, or the like.

Note that the drive transmission part 43 is formed such that, in a state where the rear tray 41 is at the first sorting position, the cam 4312 does not rotate any further even if the driving force resulting from the rotation of the drive source 44 in the first direction is transmitted. Therefore, in S1204, even if the drive source 44 rotates in the first direction in the state where the rear tray 41 and the front tray 42 are at the first sorting position, the rear tray 41 and the front tray 42 do not move in the −X direction from the first sorting position.

Next, in S1206, the control part 71 sets the variable n, which indicates the part number of the bundle of print media to be sorted, to “1.” Further, in S1208, the control part 71 sets the variable m, which indicates the sheet number of the print medium to be printed, to “1.” Then, in S1210, the control part 71 performs printing on the m-th sheet of the n-th part of the print media. In the printing part 10, a printing operation is performed in which ink is ejected while the print head 3 is moved in the X direction with respect to a predetermined area of the print media conveyed by the conveyance part 2 and supported by the platen 25. Next, after performing a conveying operation in which the conveyance part 2 conveys the print medium by a predetermined amount corresponding to the Y-direction length of the predetermined area, the printing operation is executed again. In this way, the printing part 10 performs printing on the print medium by alternately and repeatedly executing the printing operation and the conveyance operation. Therefore, the print medium is conveyed in the +Y direction during printing as the printing progresses, discharged at the end of the printing, and then stacked onto the stacking part 4, which has expanded to the first sorting position.

Then, in S1212, the control part 71 determines whether or not the print medium has been discharged. In S1212, for example, the determination is made based on a detection result of a sensor installed in the detection part 73 to detect the discharge of the print medium, and the number of discharged print media is counted. The discharged print medium is stacked onto the stacking part 4 at the first sorting position (see FIG. 13D).

In the present embodiment, the printing on the first sheet of the first part of print media is started after the rear tray 41 and the front tray 42 are moved to the first sorting position and then the front tray 42 is moved to the stack position; however, there is no such limitation. The above-described movements of the rear tray 41 and the front tray 42 only need to be completed by the time the first sheet of the first part of print media is discharged to the stacking part 4, and thus the movements and the printing on the first sheet of the first part of print media may be executed in parallel. Note that the phrase “by the time the first sheet of the first part of print media is discharged to the stacking part 4” refers, for example, to the time by which the first sheet of the first part of print media is discharged and placed onto the stacking part 4.

Thereafter, in S1214, whether or not the discharged print media have reached a predetermined number of sheets is determined. In S1214, whether or not the count of the discharged print media has reached a predetermined number of sheets, which is set in advance, is to be determined. Alternatively, in S1214, it is also possible to determine whether or not the sheet number m has reached a predetermined sheet number. In this case, in S1212, the count of the number of discharged print media is not performed. The predetermined sheet number is set based on information set in the job, for example. That is, in the present embodiment, the predetermined sheet number is “M,” and in S1214, whether or not m=M is to be determined.

In S1214, if it is determined that the discharged print media have not reached the predetermined number of sheets, the processing proceeds to S1216, where the control part 71 increments m, and the processing returns to S1210. Further, in S1214, if it is determined that the discharged print media have reached the predetermined number of sheets, the processing proceeds to S1218, where the control part 71 determines whether or not the part number n has reached a predetermined part number. The predetermined part number is set based on information set in the job, for example. That is, in the present embodiment, the predetermined part number is “N”, and in S1218, whether or not n=N is to be determined.

In S1218, if it is determined that the part number n has reached the predetermined part number, the processing proceeds to S1220, where the control part 71 determines whether or not the print media have been removed from the stacking part 4. In S1220, the determination is made based on a detection result of a sensor installed in the detection part 73 to detect whether or not any print medium is stacked on the stacking part 4. In S1220, if it is determined that the print media have not been removed from the stacking part 4, the processing of S1220 is performed again. At this time, it is also possible to provide, via the display panel 82 of the operation part 8, a notification to prompt the user to remove the print media from the stacking part 4. Further, in S1220, if it is determined that the print medium has been removed from the stacking part 4, the processing proceeds to S1222, where the rear tray 41 and the front tray 42 are moved to the second sorting position. In S1222, the drive source 44 is rotated in the second direction to move the rear tray 41 and the front tray 42, which are at the first sorting position, in the +X direction to the second sorting position, and then the processing proceeds to S1246 described later.

Further, in S1218, if it is determined that the part number n has not reached the predetermined part number, the processing proceeds to S1224, where the control part 71 moves the rear tray 41 and the front tray 42 to the second sorting position (see FIG. 13E). Since the details of processing of S1224 are the same as those of S1222 described above, the detailed explanations thereof are omitted. Next, in S1226, the control part 71 increments the variable n. Further, in S1228, the control part 71 sets the variable m to “1.” Thereafter, in S1230, the control part 71 performs printing on the m-th sheet of the n-th part of the print media. The print medium is conveyed in the +Y direction during printing as the printing progresses, discharged at the end of the printing, and then stacked onto the stacking part 4, which has expanded to the second sorting position. Then, in S1232, the control part 71 determines whether or not the print medium has been discharged. Note that the herein-discharged print medium is to be stacked onto the print medium stacked in the stacking part 4 at the first sorting position, i.e., to be stacked at a position offset in the X direction relative to the print media stacked at the first sorting position (see FIG. 13F).

In the present embodiment, the printing on the first sheet of the n-th part of the print media is performed after the rear tray 41 and the front tray 42 are moved to the second sorting position; however, there is no such limitation. The movements of the rear tray 41 and the front tray 42 to the second sorting position only need to be completed by the time the first sheet of the n-th part of the print media is discharged to the stacking part 4, and thus the movements and the printing on the first sheet of the n-th part of the print media may be executed in parallel. Note that the phrase “by the time the first sheet of the n-th part of the print media is discharged to the stacking part 4” refers, for example, to the time by which the first sheet of the n-th part of the print media is discharged and placed onto the print medium stacked on the stacking part 4.

Thereafter, in S1234, whether or not the discharged print media have reached the predetermined number of sheets is determined. In S1234, if it is determined that the discharged print media have not reached the predetermined number of sheets, the processing proceeds to S1236, where the control part 71 increments m, and the processing returns to S1230. Further, in S1234, if it is determined that the discharged print media have reached the predetermined number of sheets, the processing proceeds to S1238, where the control part 71 determines whether or not the part number n has reached a predetermined part number. Note that since the specific details of processing of S1232 through S1238 described above are the same as those of S1212 through S1218 described above, the detailed explanations thereof are omitted.

In S1238, if it is determined that the part number n has not reached the predetermined part number, the processing proceeds to S1240, where the control part 71 increments n. Then, in S1242, the control part 71 moves the rear tray 41 and the front tray 42 to the first sorting position, and the processing returns to S1208. In S1242, the drive source 44 is rotated in the first direction to move the rear tray 41 and the front tray 42, which are at the second sorting position, in the −X direction to the first sorting position.

In the present embodiment, after moving the rear tray 41 and the front tray 42 to the first sorting position in S1242, the processing returns to S1208, where the printing on the first sheet of the n-th part of the print media is performed; however, there is no such limitation. The movements of the rear tray 41 and the front tray 42 to the first sorting position in S1242 only need to be completed by the time the first sheet of the n-th part of the print media is discharged to the stacking part 4, and thus the movements and the printing on the first sheet of the n-th part of the print media may be executed in parallel.

Further, in S1238, if it is determined that the part number n has reached the predetermined part number, the processing proceeds to S1244, where the control part 71 determines whether or not the print media have been removed from the stacking part 4. Since the details of processing of S1244 are the same as those of S1220 described above, the detailed explanations thereof are omitted. In S1244, if it is determined that the print media have not been removed from the stacking part 4, the processing of S1244 is performed again. At this time, it is also possible to provide, via the display panel 82 of the operation part 8, a notification to prompt the user to remove the print media from the stacking part 4. In S1244, if it is determined that the print media have been removed from the stacking part 4, the processing proceeds to S1246, where the control part 71 moves the front tray 42 from the stack position to the accommodated position, and ends this print processing. Note that at the time of ending the print processing, for example, the rear tray 41 and the front tray 42 in the accommodated position are moved to the initial position (see FIG. 13A).

In S1246, in the state where the rear tray 41 and the front tray 42 are at the second sorting position, the drive source 44 is further rotated in the second direction, thereby moving the front tray 42 in the −Y direction from the stack position to the accommodated position. Note that the drive transmission part 43 is formed such that, in a state where the rear tray 41 is at the second sorting position, the cam 4312 does not rotate any further even if the driving force resulting from the rotation of the drive source 44 in the second direction is transmitted. Therefore, in S1246, even if the drive source 44 rotates in the second direction in the state where the rear tray 41 and the front tray 42 are at the second sorting position, the rear tray 41 and the front tray 42 do not move in the +X direction from the second sorting position.

As described above, in the present embodiment, the control part 71, the drive source 44, and the drive transmission part 43 function as a control unit that controls the movement of the stacking part 4 equipped with the rear tray 41 and the front tray 42.

### <Paper Feeding Unit>

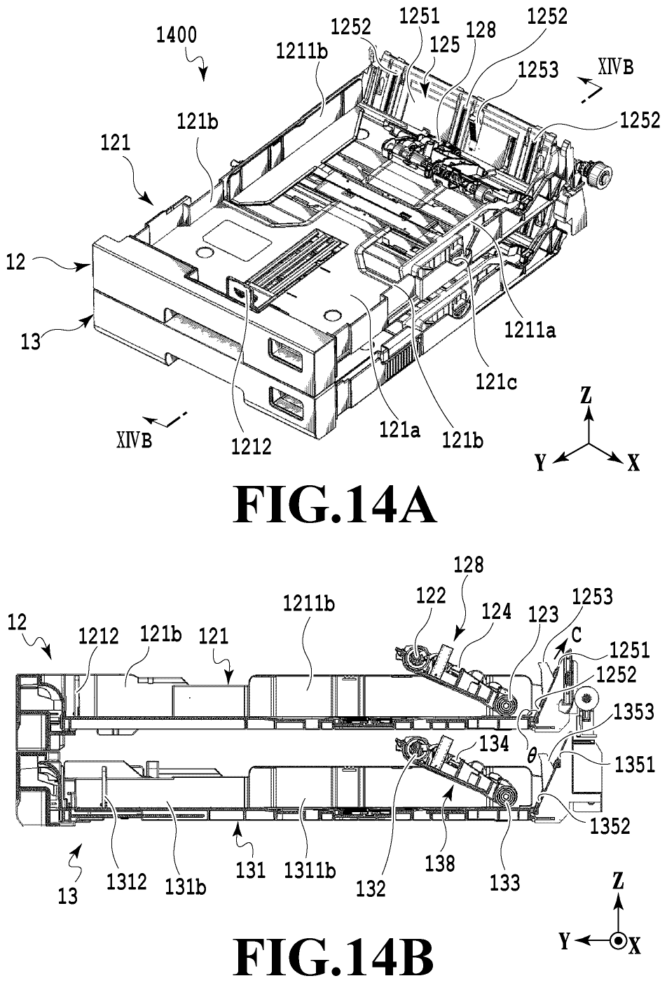

Next, a description is given about a paper feeding unit equipped with the second paper feeding part 12 and the third paper feeding part 13 installed below the printing part 10. FIG. 14A and FIG. 14B are schematic configuration diagrams of the paper feeding unit, with FIG. 14A being a perspective view, and FIG. 14B being a cross-sectional view along the XIVB-XIVB line.

The paper feeding unit 1400 includes the second paper feeding part 12 and the third paper feeding part 13 overlapping with each other, and the second paper feeding part 12 is positioned in the upper tier and the third paper feeding part 13 is positioned in the lower tier. The second paper feeding part 12 and the third paper feeding part 13 each have the function of separating and feeding one sheet of the accommodated print media to the conveyance part 2. The second paper feeding part 12 and the third paper feeding part 13 have the same configuration as each other. Therefore, only the second paper feeding part 12 is explained in the following description, and the detailed description of the third paper feeding part 13 is omitted. Note that, in the drawings, the signs attached to the respective configurations of the third paper feeding part 13 are notations in which the tens or hundreds digit of the corresponding signs attached to the respective configurations of the second paper feeding part 12 are changed from “2” to “3.”

The second paper feeding part 12 includes the cassette case 121 for accommodating print media, the swing arm 128 for feeding the accommodated print media, and the separation part 125 for separating the fed print media (see FIG. 14A). Hereinafter, a detailed description is given about each member.

### <Cassette Case>

The cassette case 121 has a substantially box-like shape with an open top and is capable of accommodating stacked print media therein. Further, the cassette case 121 is configured to be detachable from the printing part 10. In the printing part 10, the user removes the cassette case 121 from the mounted state, accommodates print media inside the cassette case 121, and then inserts and mounts the cassette case 121 into the printing part 10, thereby replenishing the print media.

In the state where the cassette case 121 is mounted to the printing part 10, the cassette case 121 is urged and pressed in a predetermined direction by a spring (not illustrated in the drawings) installed in the printing part 10. Accordingly, the cassette case 121 mounted to the printing part 10 is held in a predetermined position, thereby suppressing the occurrence of variations in the position of the print media to be fed.

The cassette case 121 includes the side guides 1211a and 1211b that restrict movement of the accommodated print media in the width direction (the X direction), and the end guide 1212 that restricts movement of the print media in the +Y direction.

The side guides 1211a and 1211b are supported so as to be movable in the X direction on the bottom surface 121a of the cassette case 121, for example, and are configured to interlock with each other via a rack and pinion mechanism (not illustrated in the drawings). Specifically, the configuration is such that if the side guide 1211b located on one side in the X direction moves in the +X direction, the side guide 1211a located on the other side in the X direction moves in the −X direction by a distance that approximately matches the movement distance of the side guide 1211b.

The end guide 1212 is supported so as to be movable in the Y direction on the bottom surface 121a of the cassette case 121. In the present embodiment, the height (the length in the Z direction) of the side guides 1211a and 1211b and the end guide 1212 is approximately the same as the highest point of the side surfaces 121b of the cassette case 121. Note that in the side surfaces 121b, the notches 121c are formed in portions that potentially become adjacent to the side guides 1211a and 1211b in the X direction. Accordingly, even if the side guides 1211a and 1211b are adjacent to the side surfaces 121b, the user can easily grips the side guides 1211a and 1211b.

After stacking and accommodating print media in the cassette case 121, the user moves the side guides 1211a and 1211b to bring them into abutment with the print media and also moves the end guide 1212 to bring it into abutment with the print media. Accordingly, the print media are always positioned at approximately the center in the X direction and on one side in the Y direction (the upstream side in the paper feeding direction) within the cassette case 121, regardless of their size. Therefore, the print media accommodated in the cassette case 121 are stably fed by the swing arm 128.

### <Swing Arm>

The swing arm 128 is installed on the rear side of the cassette case 121 (one side in the Y direction). The swing arm 128 is configured with a driving mechanism, and applies force to a print medium accommodated in the cassette case 121, thereby feeding the print medium. The swing arm 128 includes the second paper feeding shaft gear 122 to which motive power is transmitted, the second paper feeding roller 123, and the multiple second paper feeding idler gears 124 that transmit the motive power transmitted to the second paper feeding shaft gear to the second paper feeding roller 123 (see FIG. 14B).

In the swing arm 128, the second paper feeding roller 123 comes into contact with the topmost print medium among the print media accommodated in the cassette case 121. In this state, upon transmission of motive power to the second paper feeding shaft gear 122 by a drive train (not illustrated in the drawings), the motive power is transmitted to the second paper feeding roller 123 via the second paper feeding idler gear 124. The second paper feeding roller 123 rotates upon transmission of the motive power, thereby transferring the abutting print medium in the −Y direction for feeding it. Thus, in the present embodiment, the swing arm 128 functions as a transfer part that transfers a print medium for feeding of the print medium.

### <Separation Part>

The separation part 125 includes the separation slope 1251 that guides the print media fed by the second paper feeding roller 123 to the conveyance part 2, and the separation resistance bodies 1252 installed on the separation slope 1251. Further, the separation part 125 includes the set bar 1253 that restricts the movement of the print media in the −Y direction on the separation slope 1251 (see FIG. 14A).

The separation slope 1251 is an inclined surface where the angle θ formed with the bottom surface 121a of the cassette case 121, i.e., with the stacking surface of the print media, is an obtuse angle (see FIG. 14B). Accordingly, the print media transferred in the −Y direction by the second paper feeding roller 123 are transferred in the direction of arrow C by the separation slope 1251. The separation slope 1251 extends in the X direction.

A plurality (three in the present embodiment) of the separation resistance bodies 1252 is installed at different positions with respect to the X direction on the separation slope 1251 and is biased in the +Y direction by a spring (not illustrated in the drawings). Further, the separation resistance bodies 1252 have a wavelike shape that extends along the direction of arrow C, and the wavelike shape protrudes from the separation slope 1251 due to the biasing force of the spring.

The set bar 1253 is formed to be movable between a regulating position that protrudes from the separation slope 1251 to restrict the movement of the print media in the −Y direction (the position illustrated in FIG. 14A and FIG. 14B) and a retracted position that is retracted inside the separation slope 1251. The set bar 1253 is at the regulating position at the time the cassette case 121 is mounted to the printing part 10, and is at the retracted position while the print media are fed.

Thus, since the set bar 1253 is at the regulating position at the time the cassette case 121 is mounted to the printing part 10, even if the print media moves in the −Y direction due to the momentum during mounting, that movement is regulated by the set bar 1253. Further, since the set bar 1253 is in the retracted position while the second paper feeding roller 123 performs feeding, the transfer of the print media is not hindered by the set bar 1253.

A print medium fed by the second paper feeding roller 123 first contacts the separation slope 1251 at its front edge and is guided in the direction of arrow C by the separation slope 1251. The print medium that has collided with the separation slope 1251 receives the force opposing the transfer direction from the separation slope 1251 and the separation resistance bodies 1252. The force that the print medium receives at this time is set, based on the inclination angle of the separation slope 1251, the biasing force applied to the separation resistance bodies 1252 by the spring, the wavelike shape of the separation resistance bodies, etc., so that, in a case where multiple print media are fed, the topmost print medium can be separated from the other print media. As a result, even if multiple sheets of print media accommodated in the cassette case 121 are fed by the second paper feeding roller 123, only the topmost print medium will be transferred and the other print media will remain in place, due to the above-described configuration of the separation part 125.

### (Printing Unit)

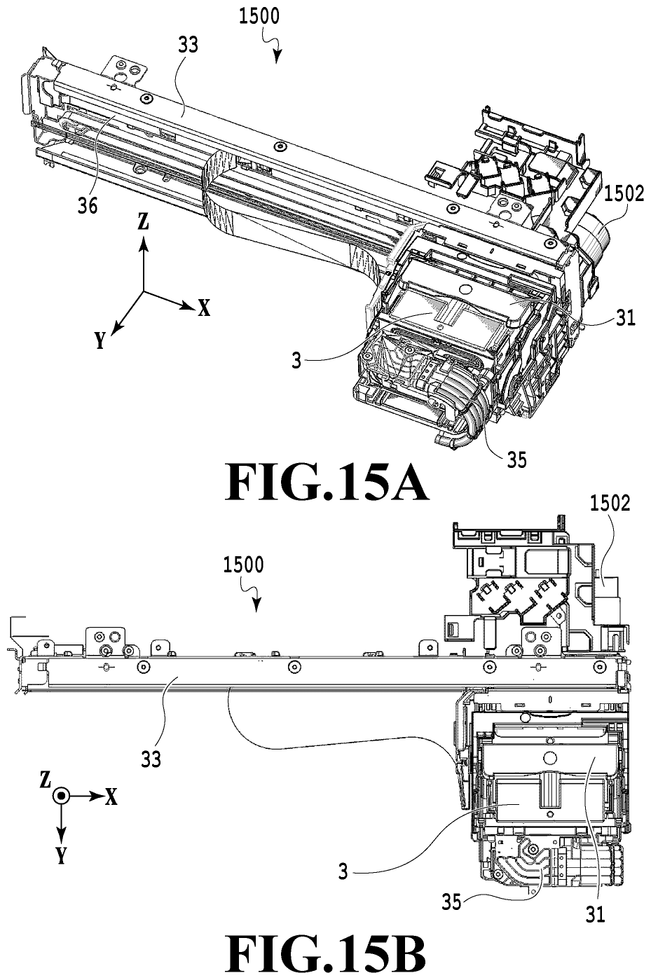

Next, a description is given of a printing unit equipped with the print head 3 and a mechanism for moving the print head 3, which includes the carriage 31. FIGS. 15A and 15B are schematic configuration diagrams of the printing unit, with FIG. 15A being a perspective view, and FIG. 15B being a plan view.

In the printing unit 1500, the carriage 31 and the chassis 33 are included as the mechanism for moving the print head 3. The chassis 33 extends in the X direction. The carriage 31 is arranged in a movable manner on the chassis 33. Inside the chassis 33, the belt 36 operated by the motor 1502 is installed, and this belt 36 is connected to the carriage 31. With this configuration, in the printing unit 1500, the belt 36 is operated by the drive of the motor 1502, allowing the carriage 31, on which the print head 3 is mounted, to reciprocate in the X direction, which is the extending direction of the chassis 33. Together with the print head 3, the tube 35 for supplying ink to the print head 3 is mounted on the carriage 31. The tube 35 is connected to the liquid storage part 34. Therefore, the ink contained in the liquid storage part 34 is supplied to the print head 3 via the tube 35.

### (Positional Relationship of the Stacking Part, the Paper Feeding Unit, and the Printing Unit)

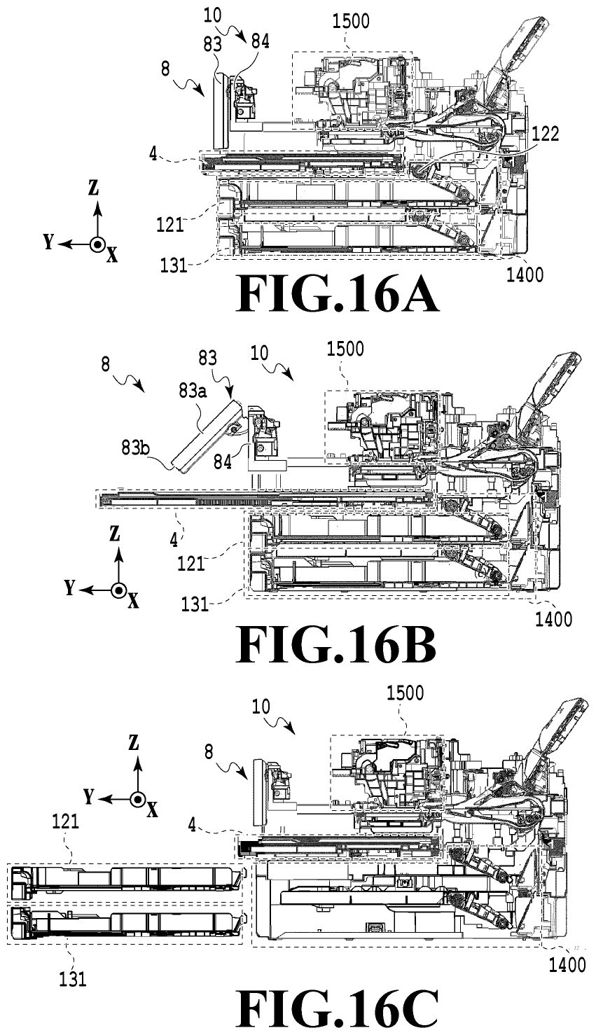

Next, a description is given about the positional relationship of the stacking part 4, the paper feeding unit 1400, and the printing unit 1500 in the printing part 10. FIG. 16A to FIG. 16C are diagrams describing the positional relationship of the stacking part 4, the paper feeding unit 1400, the printing unit 1500, and the operation part 8. FIG. 16A is a cross-sectional view along the XVIA-XVIA line of FIG. 1. FIG. 16B is a diagram corresponding to FIG. 16A and illustrating the printing part 10 during printing. FIG. 16C is a diagram corresponding to FIG. 16A and illustrating a case where the cassette cases are removed.

The stacking part 4 is arranged at a position overlapping with the cassette cases 121 and 131 in the XY plane (see FIG. 2A and FIG. 16A). Further, the stacking part 4 is arranged above the cassette case 121, which is arranged in the upper tier of the paper feeding unit 1400, at the position that does not overlap with the cassette case 121 in the Z direction (i.e., does not overlap with the cassette case 121 as viewed from the X direction) (see FIG. 16A). Note that the cassette case 121 is formed such that its upper end aligns with the upper ends of the side guides 1211a and 1211b in the Z direction (the vertical direction) and is positioned above the top surface of the maximum amount of print media that can be accommodated.

Accordingly, in the printing part 10, the cassette case 121 can be attached or detached such that the cassette case 121 and the print media accommodated in the cassette case 121 do not interfere with the stacking part 4. Therefore, in the printing part 10, while downsizing the arrangement space of the stacking part 4 and the cassette cases 121 and 131, the user can smoothly attach and detach the cassette cases 121 and 131 with the stacking part 4 being in the accommodated position (see FIG. 16C). Further, with the aforementioned positional relationship of the stacking part 4 and the cassette case 121, the stacking part 4 can be moved in the printing part 10 such that the cassette case 121 and the print media accommodated in the cassette case 121 do not interfere with the stacking part 4. Note that the movement of the stacking part 4 refers to the movement of the rear tray 41 and the front tray 42 in the X direction and the movement of the front tray 42 in the Y direction. Therefore, in the printing part 10, while downsizing the arrangement space of the stacking part 4 and the cassette cases 121 and 131, even if the maximum amount of print media is accommodated in the cassette case 121, the stacking part 4 can be smoothly moved.

The stacking part 4 is arranged at a position overlapping with the printing unit 1500 in the XY plane and below the printing unit 1500, so as not overlap with the printing unit 1500 in the Z direction (see FIG. 1 and FIG. 16A). Accordingly, the print media on which printing has been performed by the print head 3 of the printing unit 1500 can be stacked onto the stacking part 4 by gravity. In this way, since the stacking part 4 is at the position overlapping with the printing unit 1500 in the XY plane and below the printing unit 1500, the path for discharging the print media after printing can be short, thereby suppressing an increase in size of the printing part 10. Further, the stacking part 4 is arranged at a position partially overlapping with the printing unit 1500 in the Y direction, and thus an increase in size of the printing part 10 in the Y direction can be suppressed.

The second paper feeding shaft gear 122 of the second paper feeding part 12 in the upper tier of the paper feeding unit 1400 is arranged on one side (i.e., the rear side) of the stacking part 4 in the Y direction, at the position overlapping with the stacking part 4 in the X direction and the Z direction (see FIG. 16A). In other words, as viewed from the Y direction, the second paper feeding shaft gear 122 is arranged at a position overlapping with the stacking part 4. Accordingly, while maximally ensuring the movement of the front tray 42 of the stacking part 4 from the accommodated position to the stack position, i.e., the expansion length of the stacking part 4, an increase in size of the printing part 10 in the Y direction and the Z direction can be suppressed.

The operation part 8 is arranged in front of the printing part 10 and above the stacking part 4 (see FIG. 2B and FIG. 16A). Further, the operation part 8 is installed such that the pivoting part 83 equipped with the operation button 81 and the display panel 82 can pivot relative to the fixed part 84 which is fixedly installed on the housing 9 (see FIG. 1). The pivoting part 83 is configured to be capable of pivotal movement in a stepwise or stepless manner from the accommodated position where the front surface 83a equipped with the display panel 82 of the pivoting part 83, etc., is approximately parallel to the XZ plane (the position illustrated in FIG. 16A). Note that in the accommodated position, the front surface 83a is approximately aligned in the Y direction with the front surface of the paper feeding unit 1400 and the front surface 9a of the housing 9 (see FIG. 6A). Further, the pivoting part 83 is configured such that, by being drawn out (pulled toward the front side), the front surface 83a faces upward (see FIG. 16B).

By pivotally moving the pivoting part 83 to any desired angle from the accommodated position, the user can adjust the angle for easier operation of the operation button 81 and better visibility of the display on the display panel 82. Further, the operation part 8 is arranged above the stacking part 4, thereby enabling user operations to be performed without being obstructed by the print media stacked in the stacking part 4. Further, by configuring the lower end 83b to be drawn forward to change the posture of the pivoting part 83, an increase in size of the printing part 10 in the Y direction and the Z direction can be suppressed.

Note that, in order to suppress an increase in size of the printing part 10 in the Z direction, the operation part 8 is positioned such that, while the pivoting part 83 is in the accommodated position, the pivoting part 83 may interfere with the print media to be discharged and stacked onto the stacking part 4. However, in the printing part 10, the pivoting part 83 pivots from the accommodated position, thereby allowing the pivoting part 83 not to interfere or to hardly interfere with the print media to be discharged and stacked. The printing part 10 is configured such that, for example, during print processing, the user pivotally moves the pivoting part 83 from the accommodated position to the retracted position (the position illustrated in FIG. 16B) where the pivoting part 83 no longer interferes with the print media to be discharged.

Note that the printing part 10 may also have a configuration that causes the pivoting part 83 to automatically pivot from the accommodated position to the retracted position while, for example, the front tray 42 moves from the accommodated position to the stack position. In this case, it is assumed that the printing part 10 includes a pivoting mechanism that causes the pivoting part 83 to pivot between the accommodated position and the retracted position, and a drive part that drives the pivoting mechanism. The control part 71 drives the pivoting mechanism via the drive part at the time of moving the front tray 42 from the accommodated position to the stack position, thereby moving the pivoting part 83 from the accommodated position to the retracted position. Further, at the time the front tray 42 is moved from the stack position to the accommodated position, the control part 71 drives the pivoting mechanism via the drive part to move the pivoting part 83 from the retracted position to the accommodated position. Note that the configuration for causing the pivoting part 83 to pivot in accordance with the movement of the front tray 42 is not limited to this, and various known technologies may be used.

### (Reversal Conveying Paths)

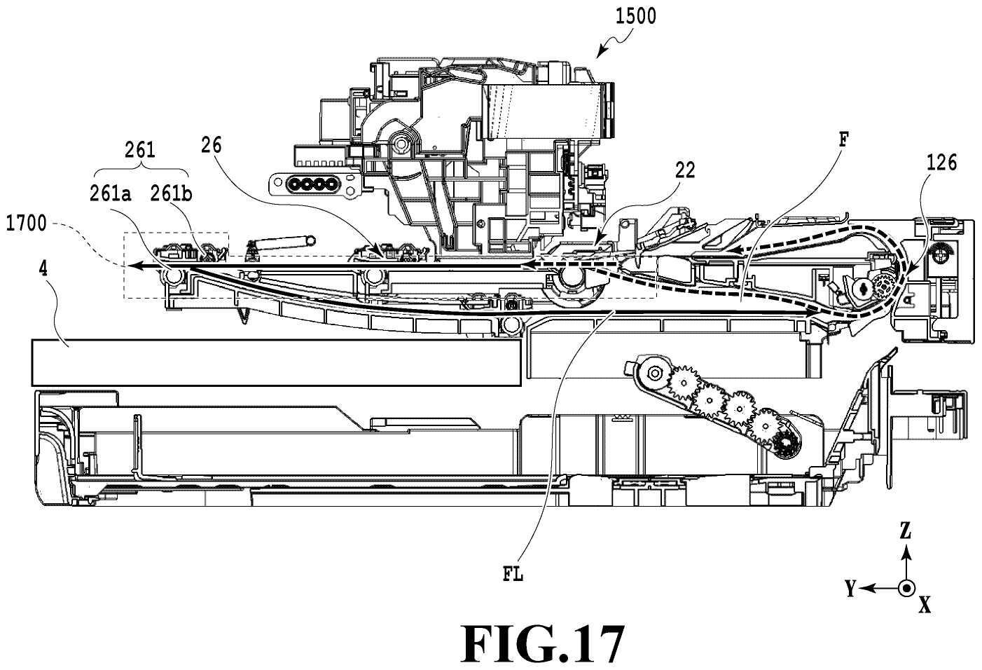

Next, a description is given about the reversal conveying paths for reversing a print medium after printing on one side, so that printing can be performed on the other side, and conveying it to the printing position. FIG. 17 is a schematic configuration diagram of the reversal conveying paths.

In the present embodiment, the printing part 10 includes the reversal conveying path F for reversing a relatively small-sized print medium after printing on one side, so that printing can be performed on the other side, and conveying it to the printing position. Further, in the present embodiment, the printing part 10 includes the reversal conveying path FL for reversing a relatively large-sized print medium after printing on one side, so that printing can be performed on the other side, and conveying it to the printing position. Note that the printing position refers to the position where printing can be performed by the print head 3.

Further, the printing part 10 includes the conveyance roller pair 22 that conveys a print medium to the printing position, and the paper discharge roller pair 26 (hereinafter referred to as “the first paper discharge roller pair 26”) that conveys the print medium after printing in the discharge direction. Furthermore, the printing part 10 includes the second paper discharge roller pair 261 that conveys the print medium, which has been conveyed by the first paper discharge roller pair 26, in the discharge direction. The second paper discharge roller pair 261 includes the paper discharge roller 261a driven by the conveyance motor 21, and the spur 261b, such that print media are conveyed by the paper discharge roller 261a and the spur 261b cooperating with each other. Note that in FIG. 1, FIG. 3A, FIG. 3B, FIG. 16A, FIG. 16B, and FIG. 16C, illustration of the second paper discharge roller pair 261 is omitted for ease of understanding.

Note that in the following description, the conveyance roller pair 22, the first paper discharge roller pair 26, and the second paper discharge roller pair 261 are collectively referred to as the conveyance unit 1700 as appropriate. In the printing part 10, the conveyance unit 1700 is formed between the printing unit 1500 and the stacking part 4 in the Z direction, at the position that does not overlap with the stacking part 4. That is, from above in the Z direction, the printing unit 1500, the conveyance unit 1700, and the stacking part 4 are arranged in this order. Furthermore, the reversal conveying paths F and FL are formed above the stacking part 4 with respect to the Z direction.

The reversal conveying path F for reversing a relatively small-sized print medium is formed on one side (the rear side) in the Y direction relative to the conveyance roller pair 22. Note that the path length of a reversal conveying path must be longer than the length of conveyed print media in the conveyance direction (the Y direction). Therefore, if the reversal conveying path FL for reversing a relatively large-sized print medium is formed on the one side in the Y direction relative to the conveyance roller pair 22, the size of the printing part 10 increases in the Y direction.

Thus, in the present embodiment, the reversal conveying path FL is formed from the other side (the front side) in the Y direction relative to the conveyance roller pair 22, extending over the one side of the conveyance roller pair 22 in the Y direction. Further, in the printing part 10, the positional relationship is such that the reversal conveying path F does not overlap with the stacking part 4 in the Y direction, whereas the reversal conveying path FL partially overlaps with the stacking part 4. In other words, as viewed from the X direction, the reversal conveying path F does not overlap with the stacking part 4, and the reversal conveying path FL partially overlaps with the stacking part 4. Accordingly, an increase in size of the printing part 10 in the Y direction is suppressed, and an increase in size of the printing apparatus 1 in the Y direction is also suppressed.

In a case where a relatively small-sized print medium is reversed and conveyed to the printing position, the conveyance motor 21 is rotated in reverse from a state where the vicinity of the rear edge of the print medium, on which printing has been performed on one side, is nipped by the first paper discharge roller pair 26. Accordingly, the first paper discharge roller pair 26, the second paper discharge roller pair 261, and the conveyance roller pair 22 rotate in the direction opposite to the rotation for conveying the print medium in the conveyance direction, and the print medium held in the vicinity of the rear edge by the first paper discharge roller pair 26 is conveyed to the reversal conveying path F. Then, once the front edge of the print medium conveyed to the reversal conveying path F passes through the conveyance roller pair 22, the conveyance motor 21 is switched to forward rotation. Thereafter, the print medium is conveyed by the first intermediate roller pair 126 to the conveyance roller pair 22. In the description provided herein, it is assumed that the rear edge of the print medium refers to the rear edge of the print medium in the conveyance direction (+Y direction) during printing one side, and the front edge of the print medium refers to the front edge of the print medium in the conveyance direction during printing on one side.

In a case where a relatively large-sized print medium is reversed and conveyed to the printing position, the conveyance motor 21 is rotated in reverse from a state where the vicinity of the rear edge of the print medium, on which printing has been performed on one side, is nipped by the second paper discharge roller pair 261. Accordingly, the first paper discharge roller pair 26, the second paper discharge roller pair 261, and the conveyance roller pair 22 rotate in the direction opposite to the rotation for conveying the print medium in the conveyance direction, and the print medium held in the vicinity of the rear edge by the second paper discharge roller pair 261 is conveyed to the reversal conveying path FL. Then, once the front edge of the print medium conveyed to the reversal conveying path FL passes through the second paper discharge roller pair 261, the conveyance motor 21 is switched to forward rotation. Thereafter, the print medium is conveyed by the first intermediate roller pair 126 to the conveyance roller pair 22.

### (Sizes of the Stacking Part, the Paper Feeding Parts, and the Printing Unit)

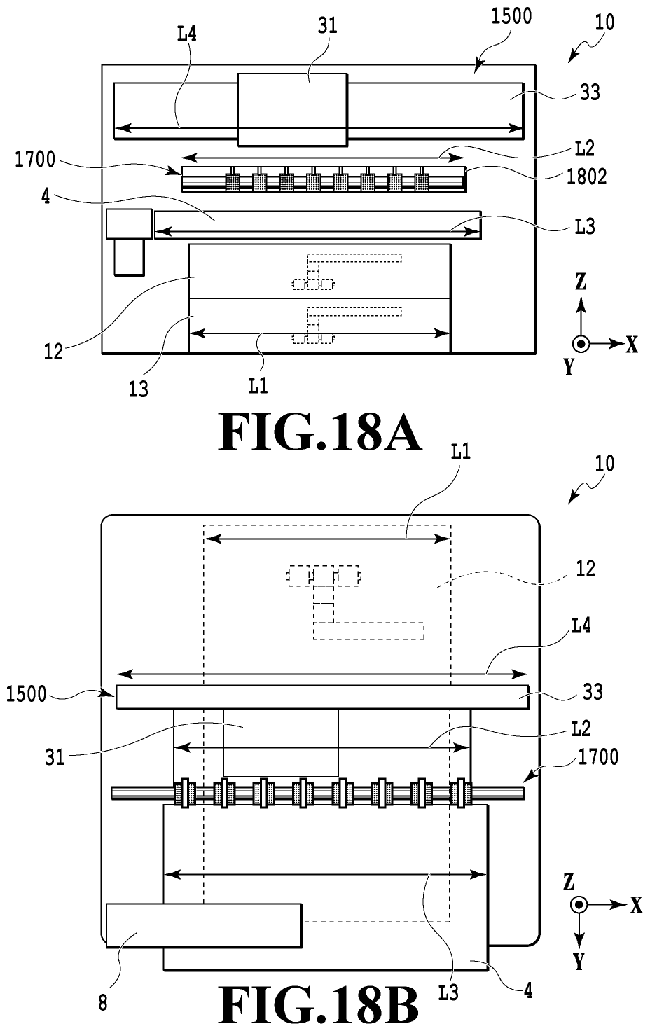

Next, a description is given of the sizes in the X direction of each configuration of the printing part 10, including the stacking part 4, the second paper feeding part 12, the third paper feeding part 13, and the printing unit 1500. FIG. 18A and FIG. 18B are diagrams illustrating the sizes in the X direction of each configuration of the printing part 10, including the stacking part, the second paper feeding part 12, the third paper feeding part 13, and the printing unit 1500. FIG. 18A is a front view, and FIG. 18B is a plan view. Note that in FIG. 18A and FIG. 18B, illustration of some configurations, such as the liquid storage part 34, is omitted for ease of understanding.

The length L1 in the X direction of the second paper feeding part 12 and the third paper feeding part 13 is designed to be longer than the X-direction length of the largest print medium that can be accommodated in the cassette cases 121 and 131 by an amount corresponding to the size of the accommodating cases. The paper discharge port 1802 where the print medium conveyed by the conveyance unit 1700 is discharged is formed between the printing unit 1500 and the stacking part 4 in the Z direction, at the position that does not overlap with the stacking part 4. The length L2 in the X direction of the paper discharge port 1802 is formed to be longer than the length L1 so as to include a certain displacement amount, thereby enabling conveyance of the print medium fed from each paper feeding part even if it becomes skewed or misaligned in the middle of the conveyance path.

The stacking part 4 is configured to change its position in the X direction to stack and sort the print media discharged from the paper discharge port 1802. Therefore, the area in which the stacking part 4 can be positioned in the X direction, i.e., the length L3 of the movement area of the stacking part 4 in the X direction, is longer than the length L2 in the X direction of the paper discharge port 1802. In the printing part 10, while moving the carriage 31 in the X direction relative to the print medium conveyed by the conveyance unit 1700, ink is ejected from the print head 3 to perform printing. Further, in the printing part 10, in order to stably execute printing, the carriage 31 is accelerated and decelerated outside the area where ink is ejected from the print head 3, and the movement of the carriage 31 is controlled to be generally uniform while the carriage 31 is moving above the print medium. Therefore, the length L4 of the movement area of the carriage 31 in the X direction is longer than the length L2 by an area required for acceleration and deceleration of the carriage 31.

Note that the length L4 of the movement area of the carriage 31 is set, for example, to a length that allows marginless printing to be executed for the X-direction length of the largest print medium printable in the printing part 10. That is, the length L4 corresponds to the length from the scanning start position to the scanning termination position of the carriage 31 performing printing on a print medium of the maximum printable size in the X direction. Note that “scanning” refers to the movement of the carriage 31 in the X direction during printing on a print medium. Therefore, the movement area of the carriage 31 spans both ends of the movement area of the stacking part 4, which has the length L3, in the X direction. Note that the stand-by position where the carriage 31 is positioned at the time printing is not being performed and the maintenance position where it is positioned at the time of performing maintenance may be installed outside the movement area that has the length L.

In the present embodiment, the length L4 of the movement area of the carriage 31 is longer than the length L3 of the movement area of the stacking part 4; however, there is no such limitation. For example, in a case where a larger spacing is to be taken for the bundles of print media being sorted or in a case where three or more sorting positions are to be provided, the length L3 may be designed to be longer than length L4.

### (Functional Effect)

As described above, in printing part 10, the rear tray 41 constituting the stacking part 4 is arranged within the housing 9, and the front tray 42 supported by the rear tray 41 is configured to be movable between the stack position drawn out from the rear tray and the accommodated position accommodated in the rear tray. Further, in printing part 10, from above, the printing unit 1500, the conveyance unit 1700, the stacking part 4, and the paper feeding unit 1400 are arranged in this order.

By arranging the conveyance unit 1700 below the printing unit 1500, the printing unit 1500 can stably eject ink without resisting gravity to perform printing on the print media conveyed by conveyance unit 1700. Further, by arranging the stacking part 4 below the conveyance unit 1700, the print media after printing are to be conveyed by the conveyance unit 1700 and discharged, and then stacked onto the stacking part 4 by gravity, and thus it is possible to shorten the path for conveyance and discharge. Moreover, by arranging the cassette case 121 of the paper feeding unit 1400 below the stacking part 4 without overlapping with each other in the Z direction, the movement of the stacking part 4 is not hindered by the cassette case 121, and the stacking part 4 does not hinder the attachment and detachment of the cassette case 121. Accordingly, in the printing part 10, the functions of the respective members are made more efficient, and adjacent members in the Z direction are arranged in a space-saving manner without interfering with each other, thereby allowing the printing apparatus 1 equipped with the printing part 10 to be downsized.

### Second Embodiment

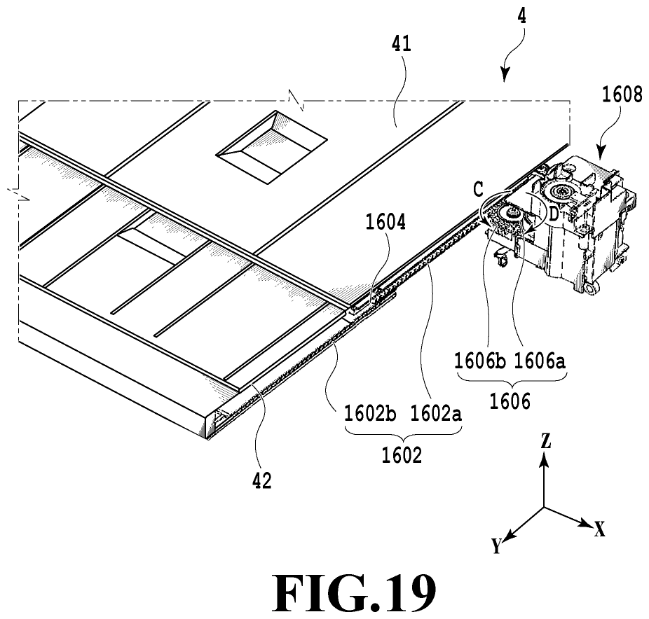

Next, with reference to FIG. 19, a description is given about the printing apparatus according to the second embodiment. In the following description, configurations that are the same or correspond to those of the printing apparatus according to the above-described first embodiment are assigned with the same signs as those used in the above-described first embodiment, thereby omitting a detailed description thereof.

In the second embodiment, a description is given about the configuration in which, out of the first embodiment, the stacking part 4 is configured to expand and contract in the Y direction via a driving mechanism installed on a side part of stacking part 4, and is configured not to move in the X direction. Hereinafter, a detailed description is given about the configuration of the driving mechanism of the stacking part 4 according to the present embodiment.

### (Driving Mechanism of the Stacking Part)

A description is given about the driving mechanism of the stacking part 4 according to the present embodiment. FIG. 19 is a diagram illustrating the driving mechanism for expanding and contracting the stacking part 4 in the Y direction according to the present embodiment. In the present embodiment, the configuration for expanding and contracting the stacking part 4 in the Y direction includes the rack 1602 installed on a side surface of the stacking part 4, and the driving member 1608 equipped with a pinion that meshes with the rack.

More specifically, the rack 1602 is formed on the side surface of the other side (the right side) of the stacking part 4 in the X direction. The rack 1602 includes the first rack part 1602a formed over substantially the entire side surface of the right side of the rear tray 41, and the second rack part 1602b formed over substantially the entire side surface of the right side of the front tray 42. Note that the first rack part 1602a includes the groove part 1604 formed in front of the first tooth. That is, on the right side surface of the rear tray 41, an area without teeth is formed in a part of the front side. Both the first rack part 1602a and the second rack part 1602b are formed with the tooth tips facing to the right. Further, both the first rack part 1602a and the second rack part 1602b are formed with the same tooth pitch.

The housing 9 includes the fixedly-installed driving member 1608 equipped with the gear 1606 that functions as a pinion meshing with the rack 1602. The gear 1606 includes the gear 1606a and the gear 1606b, which are concentric and stacked in the vertical direction (the Z direction). Both the gear 1606a and the gear 1606b are configured with the same pitch and diameter. The gear 1606a, which is positioned above, meshes with the first rack part 1602a, whereas the gear 1606b, which is positioned below, meshes with the second rack part 1602b. Note that in a case where the stacking part 4 is in the accommodated position accommodated within the housing 9, the gear 1606b meshes with the second rack part 1602b, but the gear 1606a is positioned such that its tooth tip is located in the groove part 1604, and does not mesh with the first rack part 1602a.

### (Expansion and Contraction of the Stacking Part)

In the above-described configuration, in a case where the stacking part 4 expands in the Y direction, a driving motor (not illustrated in the drawings) installed in the driving member 1608 as the drive source rotates in the forward direction, and the driving force generated by the driving motor is transmitted to the gear 1606 via multiple gears (not illustrated in the drawings). Accordingly, the gear 1606a and the gear 1606b rotate in the direction of arrow C. Note that, in addition to the driving motor, the driving member 1608 includes multiple gears for transmitting the driving force generated by the driving motor to the gear 1606.

If the gear 1606a and the gear 1606b rotate in the direction of arrow C, the front tray 42 of the stacking part 4 in the accommodated position moves in the +Y direction due to the second rack part 1602b meshing with the gear 1606b. At the time the stacking part 4 is in the accommodated position, the gear 1606b does not mesh with the first rack part 1602a, and thus the rear tray 41 does not move in the +Y direction.

Then, if the front tray 42 moves a predetermined amount in the +Y direction, the rear tray 41 moves in the +Y direction along with the movement of the front tray 42. Due to this movement of the rear tray 41, the first rack part 1602a begins meshing with the gear 1606a, thereby causing the rear tray 41 to move in the +Y direction via the first rack part 1602a with the rotation of the gear 1606a in the direction of arrow C. Note that, if the rear tray 41 moves in the +Y direction, the front tray 42 also moves in the +Y direction along with the movement of the rear tray 41, thereby causing the front tray 42 to move to the position not overlapping with the gear 1606 in the Y direction. This ends the meshing of the second rack part 1602b and the gear 1606b.

The moving amount of the stacking part 4 in the +Y direction, i.e., the expansion amount, varies according to the size of the print medium used. Note that expansion amount is controlled based on a sensor (not illustrated in the drawings) that can detect the rotation amount of the driving motor or the gears installed in the driving member 1608, for example.

Further, in a case where the stacking part 4 contracts in the Y direction, the driving motor installed in the driving member 1608 rotates in the reverse direction, and the driving force generated by the driving motor is transmitted to the gear 1606 via multiple gears. Accordingly, the gear 1606a and the gear 1606b rotate in the direction of arrow D. If the gear 1606a and the gear 1606b rotate in the direction of arrow D, the rear tray 41 moves in the −Y direction due to the first rack part 1602a meshing with the gear 1606a. At this time, the front tray 42 moves in the −Y direction along with the movement of the rear tray 41 in the −Y direction.

Then, at the time the gear 1606a is positioned in the groove part 1604, the movement of the rear tray 41 in the −Y direction stops, but the second rack part 1602b begins meshing with the gear 1606b. Accordingly, the front tray 42 begins moving in the −Y direction due to the rotation of the gear 1606b, and this movement of front tray 42 in the −Y direction moves both the front tray 42 and the rear tray 41 to the accommodated position. Note that in the present embodiment, the steps for moving to the first sorting position and moving to the second sorting position in the print processing are to be omitted.

### Modification Example

Although not specifically mentioned in the description above, it is also possible to adopt a configuration that allows selection between an automatic mode in which the stacking part 4 automatically expands and contracts using the above-described driving mechanism and a manual mode in which the user manually expands and contracts the stacking part 4. In this case, in the manual mode, for example, the gear 1606 is configured not to mesh with the gears that transmit the driving force in the driving member 1608.

In the description above, the stacking part 4 is configured not to move in the X direction; however, there is no such limitation, and, it is also possible to adopt a configuration in which the stacking part 4 is moved in the X direction using various known technologies. Further, in the description above, both the rear tray 41 and the front tray 42 are configured to be movable in the Y direction; however, there is no such limitation. It is also possible that the rear tray 41 is configured not to move in the Y direction, and only the front tray 42 is configured to move in the Y direction using the above-described driving mechanism.

### Third Embodiment

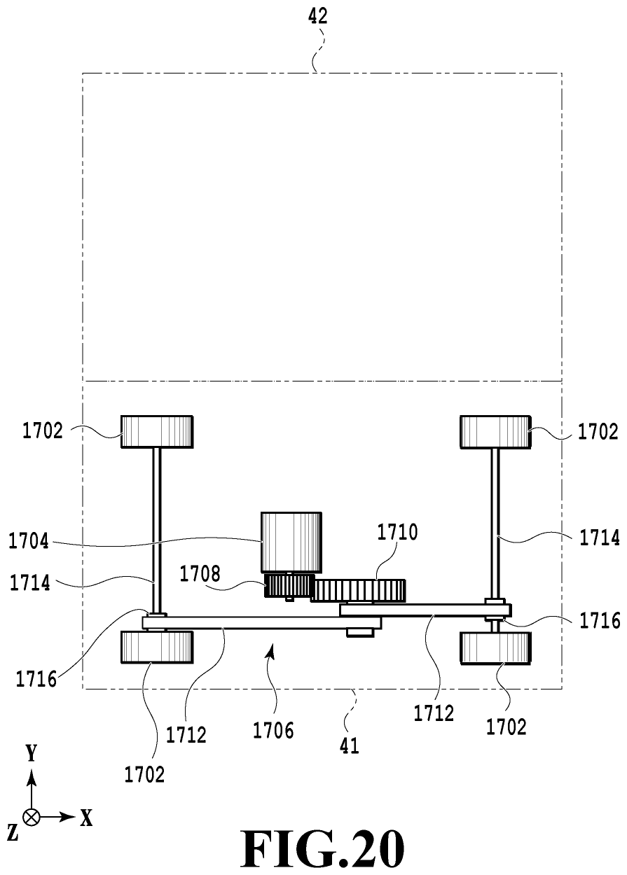

Next, with reference to FIG. 20, a description is given about the printing apparatus according to the third embodiment. In the following description, configurations that are the same or correspond to those of the printing apparatus according to the above-described first embodiment are assigned with the same signs as those used in the above-described first embodiment, thereby omitting a detailed description thereof.

In the third embodiment, a description is given about the configuration in which, out of the first embodiment, the stacking part 4 is configured to move in the X direction using the driving mechanism and not to expand or contract in the Y direction using that driving mechanism. Hereinafter, a detailed description is given about the configuration of the driving mechanism of the stacking part 4 according to the present embodiment.

### (Driving Mechanism of the Stacking Part)

A description is given about the driving mechanism of the stacking part 4 according to the present embodiment. FIG. 20 is a diagram illustrating the driving mechanism for moving the stacking part 4 in the X direction according to the present embodiment. As the configuration for moving the stacking part 4 in the X direction, the present embodiment includes the roller 1702 that rotates to enable the rear tray 41 to move in the X direction, and the driving motor 1704 that drives the roller. Note that, in the present embodiment, the front tray 42 is configured to be expandable and contractible with respect to the rear tray 41 only manually.

More specifically, the bottom surface of the rear tray 41 is equipped with the multiple rollers 1702 that allow the rear tray 41 to move in the X direction within the housing 9. In the present embodiment, each roller 1702 is arranged, on the bottom surface of the rear tray 41, at the position that does not restrict the manual expansion and contraction of the front tray 42. The rollers 1702 move, for example, on a rail (not illustrated in the drawings) installed in the housing 9 and extending in the X direction.

Further, the bottom surface of the rear tray 41 is equipped with the driving motor 1704 that is driven under the control of the control part 71, and the transmission part 1706 that transmits the driving force generated by the driving motor 1704 to the rollers 1702. The driving motor 1704 and the transmission part 1706 are also arranged on the bottom surface of the rear tray 41, at the positions that do not restrict the manual expansion and contraction of the front tray 42.

### (Movement of the Stacking Part)

The driving motor 1704 rotates based on the drive signal from the control part 71, thereby causing the drive gear 1708 to rotate, and this drive is transmitted to the drive transmission gear 1710. Then, the rotation of the drive transmission gear 1710 is transmitted via the drive transmission belt 1712 to the gear 1716, which is coupled to the shaft 1714 connecting the rollers 1702. Accordingly, as the shaft 1714 rotates, the rollers 1702 rotate in conjunction with the rotation of the shaft 1714. Further, this rotation of the rollers 1702 causes the rear tray 41 to move in the +X direction and the −X direction. The moving direction of the rear tray 41 is changed according to the rotation direction of the driving motor 1704. For example, if the driving motor 1704 rotates in the forward direction, the rear tray 41 moves in the +X direction, and if the driving motor 1704 rotates in the reverse direction, the rear tray 41 moves in the −X direction.

In the present embodiment, in the step of executing the processes of moving the front tray 42 to the stack position and the accommodated position during the print processing, a notification prompting the user to move the front tray 42 to the stack position or the accommodated position is provided on the display panel 82 of the operation part 8. Further, there may be a sensor that detects whether the front tray 42 is in the stack position or the accommodated position. The movement at this time may be performed manually by the user. With the front tray 42 having moved from the accommodated position to the stack position, the rear tray 41 is moved in the X direction, thereby sorting the print media.

### Modification Example

In the description above, the bottom surface of the rear tray 41 is equipped with the rollers 1702, the driving motor 1704, and the transmission part 1706 configured with the drive transmission gear 1710 and the like; however, there is no such limitation. For example, it is also possible to install a moving part configured with these configurations to be movable in the X direction, and the rear tray 41 is fixedly arranged on that moving part.

In the description above, the stacking part 4 is configured not to expand or contract in the Y direction automatically; however, there is no such limitation, and it is also possible to adopt a configuration in which the stacking part 4 expands or contracts automatically, using various known technologies.

### Fourth Embodiment

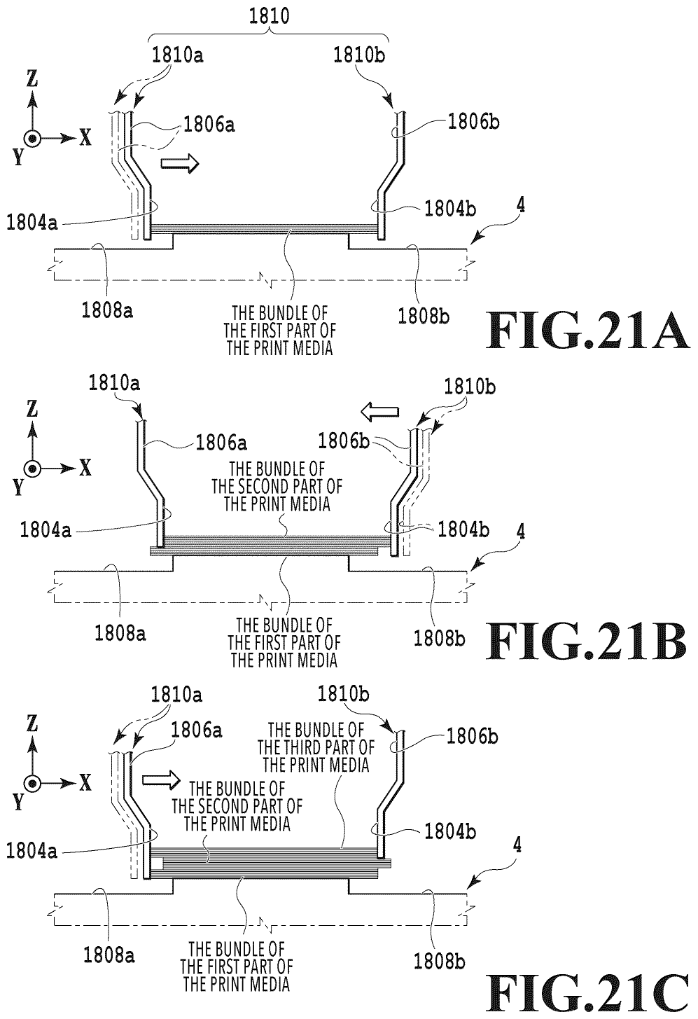

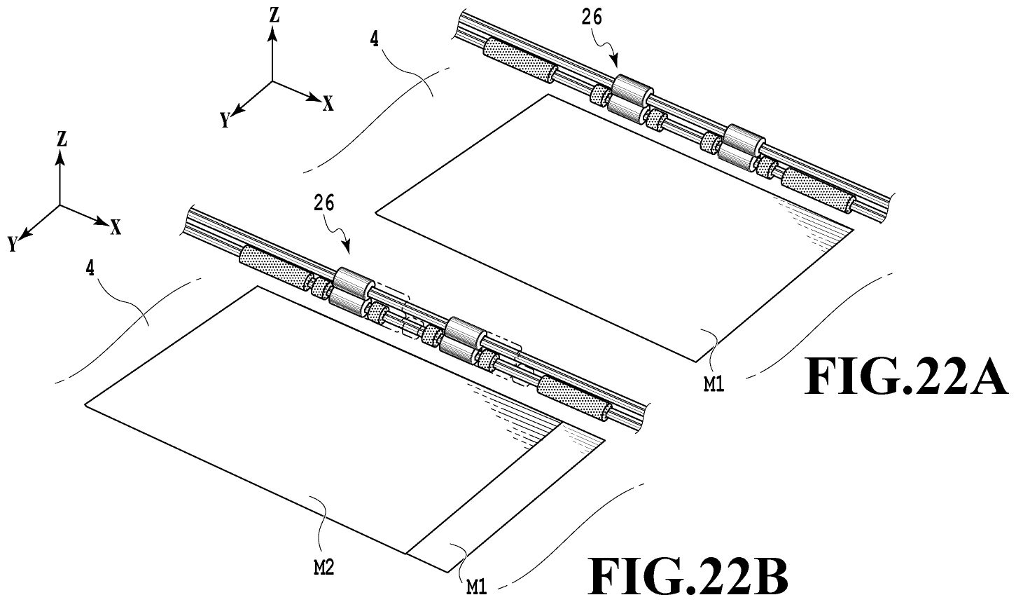

Next, with reference to FIG. 21A to FIG. 22B, a description is given about the printing apparatus according to the fourth embodiment. In the following description, configurations that are the same or correspond to those of the printing apparatus according to the above-described first embodiment are assigned with the same signs as those used in the above-described first embodiment, thereby omitting a detailed description thereof.

The fourth embodiment differs from the above-described first embodiment in that the print media to be discharged are sorted by a configuration different from the stacking part 4. Hereinafter, a detailed description is given about the configuration for sorting the print media to be discharged.

### (Configuration for Sorting the Print Media to be Discharged)

FIG. 21A to FIG. 21C are diagrams describing an alignment member, which is an example of the configuration for sorting the print media to be discharged. FIG. 21A is a diagram illustrating the alignment member sorting a bundle of the first part of the print media. FIG. 21B is a diagram illustrating the alignment member sorting a bundle of the second part of the print media. FIG. 21C is a diagram illustrating the alignment member sorting a bundle of the third part of the print media.

In the present embodiment, the printing apparatus 1 includes the alignment member 1810 that is capable of aligning the X-direction ends of the print media discharged from the paper discharge roller pair 26. The alignment member 1810 includes the pair of alignment members 1810a and 1810b, and the alignment member 1810a and the alignment member 1810b are arranged to face each other such that their spacing in the X direction can be changed.

The alignment members 1810a and 1810b are formed of plate-like bodies. The alignment part 1804a for aligning the print media discharged to the stacking part 4 is formed at the lower part of the alignment member 1810a, and the alignment part 1804b that cooperates with the alignment part 1804a to align the print media is formed at the lower part of the alignment member 1810b. The alignment parts 1804a and 1804b have flat surfaces that face each other. The multiple print media stacked in the stacking part 4 are pressed at their X-direction edges by the alignment parts 1804a and 1804b, so that their positions in the X direction are aligned.

The alignment member 1810a includes the relief part 1806a formed above the alignment part 1804a and positioned on one side in the X direction relative to the alignment part 1804a. Further, the alignment member 1810b includes relief part 1806b formed above the alignment part 1804b and positioned on the other side in the X direction relative to the alignment part 1804b. Accordingly, the relief parts 1806a and 1806b have a wider space in the X direction than the space of the alignment parts 1804a and 1804b. Further, the relief parts 1806a and 1806b become narrower in the X-direction width as they extend downward from predetermined positions, and are connected at their lower ends to the alignment parts 1804a and 1804b, respectively. Thus, in the alignment member 1810, the print media discharged between the relief parts 1806a and 1806b are likely to be guided between the alignment parts 1804a and 1804b.

The alignment member 1810 is arranged in the housing 9 so as to be capable of executing the later-described various operations. The operations of the alignment member 1810 are controlled by the control part 71. The alignment member 1810 may have a detachable configuration or a non-detachable configuration.

On one side in the X direction of the upper surface for stacking the print media in the stacking part 4, the recess part 1808a into which the tip of the alignment member 1810a can enter extends in the X direction. Further, on the other side of that upper surface in the X direction, the recess part 1808b into which the tip of the alignment member 1810b can enter extends in the X direction. In the present embodiment, the recess parts 1808a and 1808b are formed in the rear tray 41.

In a case where printing is executed on the first part of the print media in the print processing, the alignment members 1810a and 1810b stand by at the first receiving position where the alignment parts 1804a and 1804b are spaced apart by a predetermined amount wider than the width (the length in the X direction) of the print media. At this time, the front tray 42 is at the stack position. Further, at this time, the tips of the alignment members 1810a and 1810b have entered into the recess parts 1808a and 1808b, respectively (see FIG. 21A).

The print media discharged from the paper discharge roller pair 26 enter between the relief parts 1806a and 1806b of the alignment members 1810a and 1810b that are standing by at the first receiving position, and are discharged onto the upper surface of the stacking part 4 by their own weight. At this time, in the alignment members 1810a and 1810b, the relief parts 1806a and 1806b, which are spaced apart widely in the X direction, receive the print media that are discharged with some variation in position in the X direction, and guide the print media into the space between the alignment parts 1804a and 1804b. Then, after the end of the printing of the first part, the alignment member 1810a is moved in the +X direction so as to narrow the space between the alignment parts 1804a and 1804b, such that the alignment members 1810a and 1810b press and align the bundle of print media stacked on the stacking part 4 in the +X direction.

Next, at the time of transition to the printing of the second part, the alignment members 1810a and 1810b are moved to the second receiving position that is shifted by a predetermined amount in the +X direction relative to the first receiving position for the first part. At this time, the alignment member 1810a is positioned so that its tip is on the print media of the first part, whereas the alignment member 1810b is in the state where its tip has entered into the recess part 1808b (see FIG. 21B). Further, the print media discharged from the paper discharge roller pair 26 enter between the relief parts 1806a and 1806b of the alignment members 1810a and 1810b that are standing by at the second receiving position, and are discharged onto the bundle of the first part of print media by their own weight. Then, after the end of the printing of the second part, the alignment member 1810b is moved in the −X direction so as to narrow the space between the alignment parts 1804a and 1804b, such that the alignment members 1810a and 1810b press and align the bundle of print media stacked on the bundle of the first part of the print media in the −X direction.

Furthermore, at the time of transition to the printing of the third part, the alignment members 1810a and 1810b are moved to the first receiving position. At this time, the alignment member 1810b is positioned so that its tip is on the print media of the second part, whereas the alignment member 1810a is in the state where its tip has entered into the recess part 1808a (see FIG. 21C). Further, the print media discharged from the paper discharge roller pair 26 enter between the relief parts 1806a and 1806b of the alignment members 1810a and 1810b that are standing by at the first receiving position, and are discharged onto the bundle of the second part of the print media by their own weight. Then, after the end of the printing of the third part, the alignment member 1810a is moved in the +X direction so as to narrow the space between the alignment parts 1804a and 1804b, such that the alignment members 1810a and 1810b press and align the bundle of print media stacked on the bundle of the second part of the print media in the +X direction. In this way, the printing apparatus 1 is capable of sorting the bundles of print media according to the part number.

### (Another Configuration for Sorting the Print Media to be Discharged)

Moreover, the configuration for sorting the print media to be discharged is not limited to the alignment members 1810 described above. For example, the paper discharge roller pair 26 may be configured to be movable in the direction orthogonal to the discharge direction of the print media, so that sorting can be performed by shifting the position of the print media in at least two locations at the time of discharging to the stacking part 4 (see FIGS. 22A and 22B). FIG. 22A and FIG. 22B are diagrams describing another configuration for sorting the print media to be discharged, with FIG. 22A describing the discharge at the first position, and FIG. 22B describing the discharge at the second position.

Specifically, the paper discharge roller pair 26 is configured to be movable in the X direction. Further, in a case of discharging the print media M1 of an odd-numbered part, the paper discharge roller pair 26 moves, while discharging the print media M1, to the first position that is located relatively on the right side, for example, and then the print media M1 are discharged to the stacking part 4. Accordingly, the print media M1 are to be discharged to the location corresponding to the first position in the stacking part 4 (see FIG. 22A). Moreover, in a case of discharging the print media M2 of an even-numbered part, the paper discharge roller pair 26 moves, while discharging the print media M2, to the second position that is located relatively on the left side, for example, and then the print media M2 are discharged to the stacking part 4. Accordingly, the print media M2 are to be discharged to the location corresponding to the second position in the stacking part 4 (see FIG. 22B). Note that various known technologies can be used for the specific configuration for moving the paper discharge roller pair 26 to different positions at the time of discharging print media according to the part number, and thus a detailed explanation thereof is omitted.

### OTHER EMBODIMENTS

Note that the above-described embodiments may be modified as shown in the following (1) through (8).

(1) Although not specifically described in the above embodiments, in the printing apparatus 1, the print processing that performs printing on print media and sorts the print media after printing (see FIG. 12) and the print processing that does not execute the sorting can be selected based on an input from the operation part 8 or the like. In a case of the print processing that does not execute the sorting, for example, after moving to the first sorting position, the print media after printing continue to be discharged in the state where the front tray 42 has been moved to the stack position. Further, in the case of the print processing that does not execute the sorting, for example, if the control part 71 determines in S1218 that the part number n has not reached the predetermined part number, the processing proceeds to S1240. Furthermore, in the case of the print processing that does not execute the sorting, for example, S1202 and S1222 may be omitted.

Note that in the above-described embodiments, the case in which the instruction “Sort into N parts for every M sheets” is input by a job or the operation part 8 is described, using the flowchart of FIG. 12. However, in actual printing operations, even in a case where M and N are known, there may be a designation not to perform sorting. For such cases, a configuration for switching whether or not to transmit the driving force of the drive source 44 to the engagement part 4333 is installed in advance, and in a case where sorting is not performed, the stacking part 4 may be controlled not to move between the first sorting position and the second sorting position.

(2) In the above-described embodiments, the drive transmission part 43 is formed such that, in a state where the rear tray 41 is positioned at the first sorting position, the cam 4312 does not rotate any further even if the driving force resulting from the rotation of the drive source 44 in the first direction is transmitted. However, the drive transmission part 43 is not limited to this configuration. For example, the drive transmission part 43 may be formed such that, in a state where the rear tray 41 is positioned at a predetermined position on one side in the X direction relative to the first sorting position, the cam 4312 does not rotate any further even if the driving force resulting from the rotation of the drive source 44 in the first direction is transmitted. In this case, in the print processing of FIG. 12, after moving the rear tray 41 to the predetermined position, the drive source 44 is further rotated in the first direction to move the front tray 42 from the accommodated position to the stack position. Then, the drive source 44 is rotated in the second direction, thereby moving the rear tray 41 in the +X direction to the first sorting position. At this time, the position of the rear tray 41 is determined based on a detection result of a sensor installed in the detection part 73 to detect the position of the stacking part 4 after a predetermined operation.

(3) In the above-described embodiments, the drive transmission part 43 is formed such that, in a state where the rear tray 41 is at the second sorting position, the cam 4312 does not rotate any further even if the driving force resulting from the rotation of the drive source 44 in the second direction is transmitted. However, the drive transmission part 43 is not limited to this configuration. For example, the drive transmission part 43 may be formed such that, in a state where the rear tray 41 is at a predetermined position on the other side in the X direction relative to the second sorting position, the cam 4312 does not rotate any further even if the driving force resulting from the rotation of the drive source 44 in the second direction is transmitted.

(4) In the above-described embodiments, in the accommodated position, a partial area on the end portion 42a side of the front tray 42 may protrude forward in the Y direction from the housing 9 (see FIG. 6A); however, there is no such limitation. It is also possible that the front tray 42 is configured not to protrude forward from the housing 9 in the accommodated position. That is, in this case, the front tray 42 is completely accommodated within the housing 9 in the accommodated position. Further, in the above-described embodiments, the stacking part 4 sorts the ejected print media by stacking them at two locations, i.e., the first sorting position and the second sorting position; however, the positions for sorting are not limited to the two locations. For example, it is also possible to sort discharged print media at three or more different locations in the X direction.

(5) In the above-described embodiments, the printing apparatus 1 may be what is termed as a serial-scan type printing apparatus that performs printing by ejecting ink, while moving the print head 3 in the X direction, onto a print medium being conveyed; however, there is no such limitation. The printing apparatus applicable to the present disclosure may also be other type, such as, for example, what is termed as a line-type printing apparatus that performs printing on a print medium conveyed in the Y direction using a print head capable of ejecting ink within a range corresponding to a printable size of print medium with respect to the X direction.

(6) In the above-described embodiments, the first sorting position may be set such that the center position Os of the stacking part 4 in the X direction is located on one side in the X direction relative to the center position Om of the print media to be discharged, and the second sorting position is set such that the center position Os is located on the other side in the X direction relative to the center position Om. However, the first sorting position and the second sorting position are not limited to this. For example, either the first sorting position or the second sorting position may be set such that the center position Os coincides with the center position Om. Further, in the above-described embodiments, the initial position during the non-printing time in which printing is not performed may be set to the position where the center position Os of the stacking part 4 coincides with the center position Om of the print media to be discharged; however, there is no such limitation. The initial position may be set to the first sorting position, the second sorting position, or a predetermined position other than the first sorting position and the second sorting position.

(7) In the above-described embodiments, the case where the instruction “Sort into N parts for every M sheets” is set in the job is described. However, the job may also be in a form where a command to change the sorting position is interposed between the image data of a predetermined page and the image data of the next page. In this case, the control part 71 may sequentially execute operations in accordance with the received command, such as printing and discharging according to the image data of the predetermined page, changing the sorting position, and printing and discharging according to the image data of the next page.

(8) The above-described embodiments and various forms shown in (1) through (7) may be combined as appropriate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it becomes possible to downsize an apparatus.

This application claims the benefit of priority from Japanese Patent Applications No. 2024-124817, filed Jul. 31, 2024, and No. 2025-026009, filed Feb. 20, 2025, which are hereby incorporated by reference herein in their entirety.

What is claimed is:

1. A printing apparatus comprising:
an accommodating unit configured to accommodate a print medium;
a conveyance unit configured to convey the print medium fed from the accommodating unit in a first direction;
a printing unit configured to perform printing on the print medium conveyed by the conveyance unit; and
a first stacking part configured to stack the print medium, on which printing has been performed by the printing unit, at a first position and a second position which is different from the first position in a second direction intersecting with the first direction,
wherein the first stacking part is arranged above the accommodating unit, below the printing unit.

2. The printing apparatus according to claim 1,
wherein the first stacking part is movable from an accommodated position in the first direction.

3. The printing apparatus according to claim 1 further comprising
a second stacking part configured to stack the print medium,
wherein the first stacking part moves in the first direction relative to the second stacking part.

4. The printing apparatus according to claim 3 further comprising
a movement mechanism configured to move the second stacking part in the second direction,
wherein the movement mechanism moves the first stacking part together with the second stacking part.

5. The printing apparatus according to claim 4,
wherein the movement mechanism moves the first stacking part in the first direction and moves the second stacking part in the second direction.

6. The printing apparatus according to claim 1 further comprising
a movement mechanism configured to move the first stacking part in the second direction.

7. The printing apparatus according to claim 3,
wherein the first stacking part is movable between an accommodated position, in which the first stacking part is accommodated in an overlapping manner with the second stacking part, and a stack position, in which the first stacking part cooperates with the second stacking part to be able to stack the print medium.

8. The printing apparatus according to claim 1,
wherein the first stacking part stacks the print medium at a plurality of positions different from each other in the second direction.

9. The printing apparatus according to claim 1 further comprising
a reversal conveying path configured to reverse a surface of the print medium on which printing is performed by the printing unit,
wherein the reversal conveying path is arranged above the accommodating unit, at a position that does not overlap with the accommodating unit in a vertical direction intersecting with the first direction and the second direction.

10. The printing apparatus according to claim 9,
wherein the reversal conveying path includes
a first reversal conveying path formed on an upstream side in the first direction relative to the printing unit, and
a second reversal conveying path formed from a downstream side to the upstream side in the first direction relative to the printing unit.

11. The printing apparatus according to claim 1 further comprising
a transfer unit configured to transfer the print medium to feed the print medium accommodated in the accommodating unit,
wherein the transfer unit is arranged at a position that does not overlap with the first stacking part in the first direction and partially overlaps with the first stacking part in a vertical direction intersecting with the first direction and the second direction.

12. The printing apparatus according to claim 1 further comprising
an operation unit configured to be capable of displaying information and executing an operation,
wherein the operation unit is
arranged above the first stacking part, and
configured to be capable of pivoting between a first position that interferes with the print medium placed on the first stacking part and a second position that does not interfere with the print medium stacked on the first stacking part.

13. The printing apparatus according to claim 12,
wherein the operation unit is pivotally moved from the first position to the second position in a case where the first stacking part moves in the first direction from the accommodated position.

14. The printing apparatus according to claim 1,
wherein the accommodating unit is detachable, and
wherein the accommodating unit and the first stacking part are arranged adjacent to each other in a vertical direction intersecting with the first direction and the second direction, at positions that do not interfere with each other's operation.

15. The printing apparatus according to claim 1,
wherein the first stacking part, in an accommodated position, is arranged at a position partially overlapping with the printing unit in the first direction.

16. The printing apparatus according to claim 1,
wherein a discharge port through which the print medium is discharged is formed between the printing unit and the first stacking part in a vertical direction intersecting with the first direction and the second direction, at a position not overlapping with the first stacking part, and
wherein the length in the second direction of the discharge port through which the print medium is discharged is longer than the length in the second direction of a paper feeding unit that feeds the print medium accommodated in the accommodating unit.

17. The printing apparatus according to claim 16,
wherein the length of an area in which the first stacking part can be positioned in the second direction is longer than the length of the discharge port in the second direction.

18. The printing apparatus according to claim 16,
wherein the printing unit performs printing on the print medium while moving in the second direction, and
wherein the length an area in which the printing unit moves is longer than the length of an area in which the first stacking part can be positioned in the second direction.
